(19) United States
(12) Patent Application Publication
(10) Pub. No.: US 2025/0110569 A1
(43) Pub. Date: Apr. 3, 2025

(54) Devices, Methods, and Graphical User Interfaces for Processing Inputs to a Three-Dimensional Environment

(71) Applicant: Apple Inc., Cupertino, CA (US)

(72) Inventors: Mark A. Ebbole, San Francisco, CA (US); Bharat C. Dandu, Santa Clara, CA (US); Daniel J. Brewer, Redwood City, CA (US)

(21) Appl. No.: 18/886,891

(22) Filed: Sep. 16, 2024

Related U.S. Application Data
(60) Provisional application No. 63/541,759, filed on Sep. 29, 2023.

(51) Int. Cl. G06F 3/01; G06T 19/00

(52) U.S. Cl. CPC G06F 3/017; G06T 19/006

(57) ABSTRACT

While a view of an environment is visible via a display generation component, a computer system displays a user interface including one or more user interface objects. The computer system detects, via one or more input devices, one or more inputs; and, if the one or more inputs include a first input performed using a first input manipulator and a second input performed using a second input manipulator distinct from the first input manipulator, where the first input and the second input meet concurrency criteria, the computer system: provides a first input event for the first input to a first application and a second input event for the second input to the first application. The first input includes information identifying a target location and the second input event also includes information identifying the target location.

### RELATED APPLICATIONS

This application claims priority to U.S. Provisional Application No. 63/541,759, filed Sep. 29, 2023, which is hereby incorporated by reference in its entirety.

### TECHNICAL FIELD

The present disclosure relates generally to computer systems that are in communication with a display generation component and one or more input devices, and that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for processing inputs to a three-dimensional environment that includes at least some virtual elements (e.g., applications, augmented reality environments, mixed reality environments, and virtual reality environments) are cumbersome, inefficient, and limited. For example, systems that provide incomplete support for receiving inputs performed using multiple input manipulators are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for processing inputs to computer-generated experiences that make interaction with computer systems that support multiple input manipulators more seamless, efficient, and intuitive for a user. Such methods and interfaces optionally complement or replace conventional methods for processing inputs when providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is a portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has a touch-sensitive display (also known as a “touch screen” or “touch-screen display”). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for processing inputs to a three-dimensional environment. Such methods and interfaces may complement or replace conventional methods for processing inputs to a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In accordance with some embodiments, a method is performed at a computer system that is in communication with a display generation component and one or more input devices. The method includes, while a view of an environment is visible via the display generation component, displaying a user interface including one or more user interface objects. The method includes detecting, via the one or more input devices, one or more inputs. The method includes, in accordance with a determination that the one or more inputs include a first input performed using a first input manipulator and a second input performed using a second input manipulator distinct from the first input manipulator, where the first input and the second input meet concurrency criteria: providing a first input event for the first input to a first application, the first input event including information identifying a target location; and providing a second input event for the second input to the first application, the second input event including information identifying the target location.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIG. 1A is a block diagram illustrating an operating environment of a computer system for providing extended reality (XR) experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate an XR experience for the user in accordance with some embodiments.

FIG. 3 is a block diagram illustrating a display generation component of a computer system that is configured to provide a visual component of the XR experience to the user in accordance with some embodiments.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7S illustrate example techniques for processing inputs performed using different numbers of input manipulators, in accordance with some embodiments.

FIGS. 8A-8D are flow diagrams of methods of processing inputs performed using different numbers of input manipulators, in accordance with various embodiments.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system detects one or more inputs, and if the one or more inputs include a first input performed using a first input manipulator and a distinct second input performed using a distinct second input manipulator, and the first input and the second input meet concurrency criteria, the computer system provides, to an application associated with a common target location of the inputs, a first input event for the first input and a second input event for the second input, the first input event and the second input event both including information identifying the target location. In some embodiments, the first input event and the second input event are associated with, and optionally include, information identifying different respective input locations in addition to the common target location. This enables the receiving application to distinguish between concurrent inputs from different input manipulators and also to understand relative locations and relative movement of the input manipulators and use this information in performing a user interface operation in response, rather than only knowing location and movement of the input manipulators independently of each other, thereby increasing flexibility in input processing and the range of inputs supported.

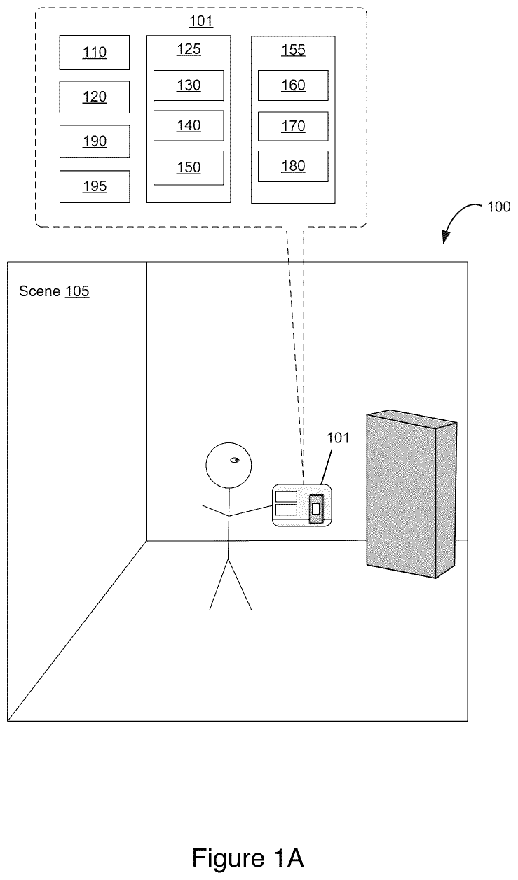

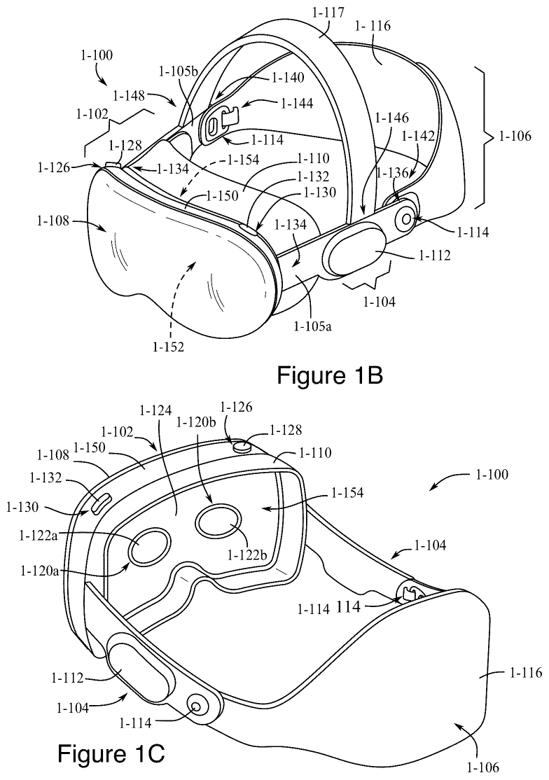

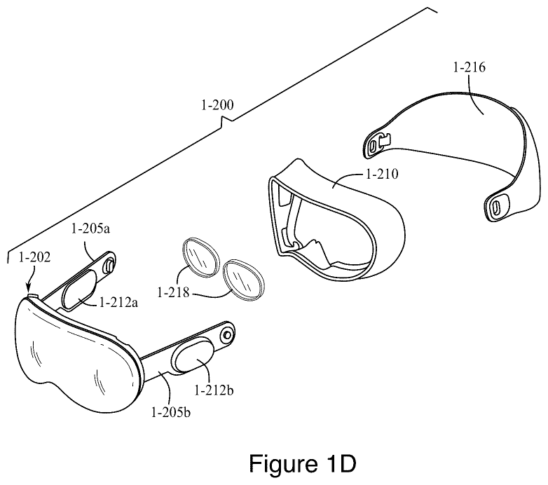

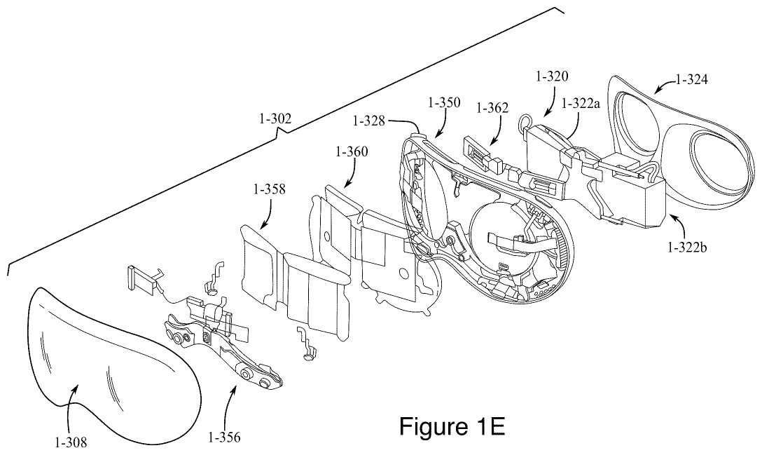

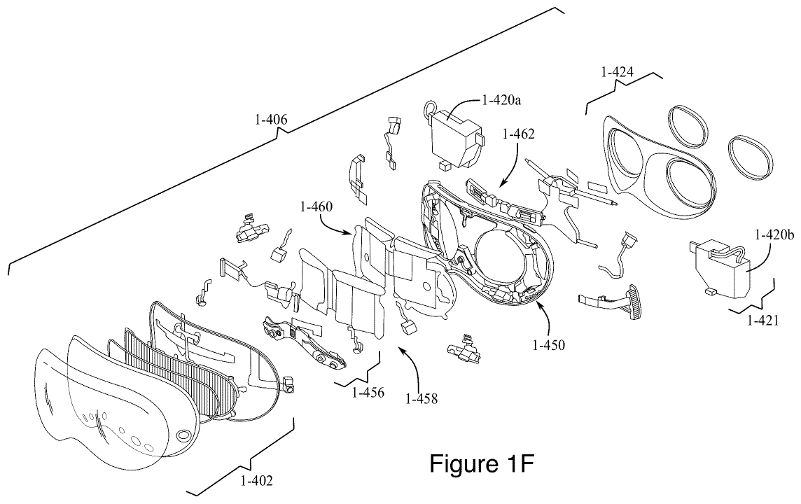

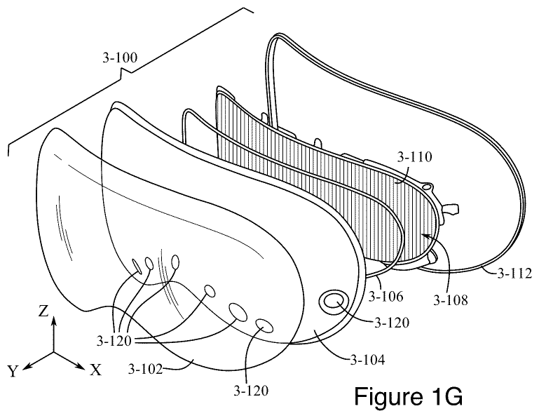

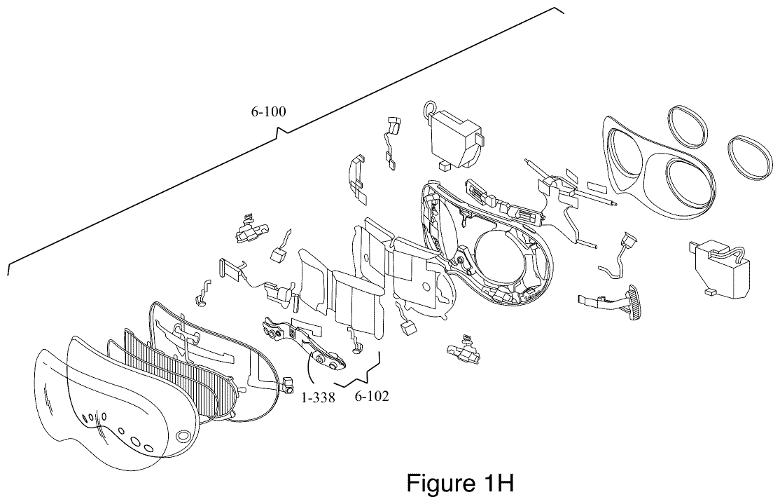

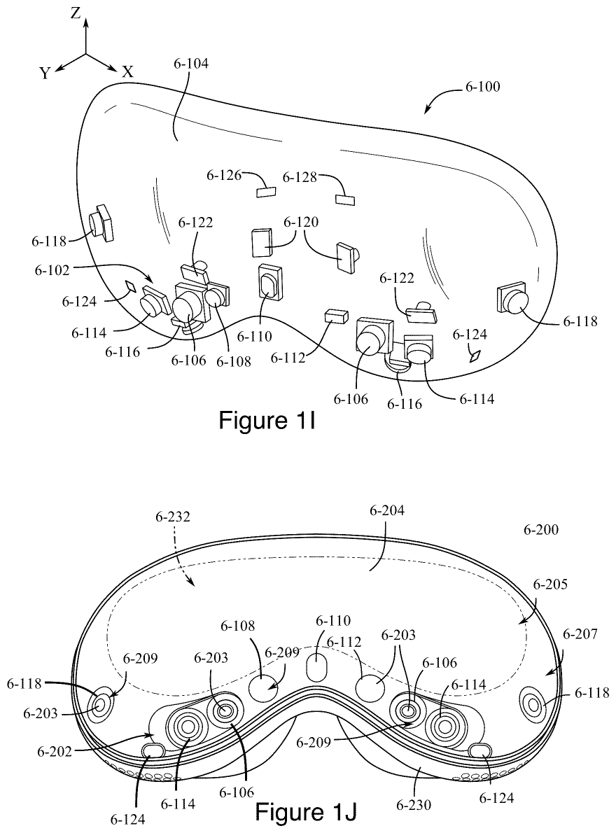

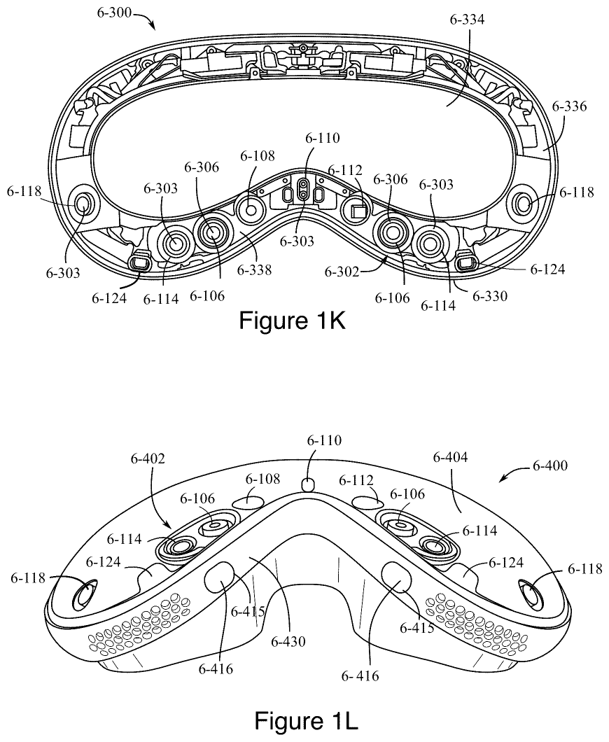

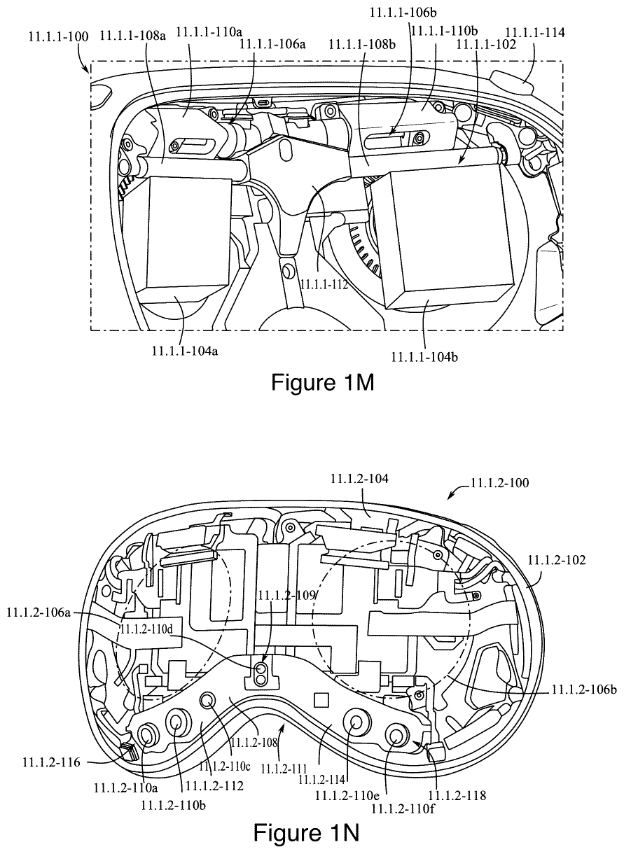

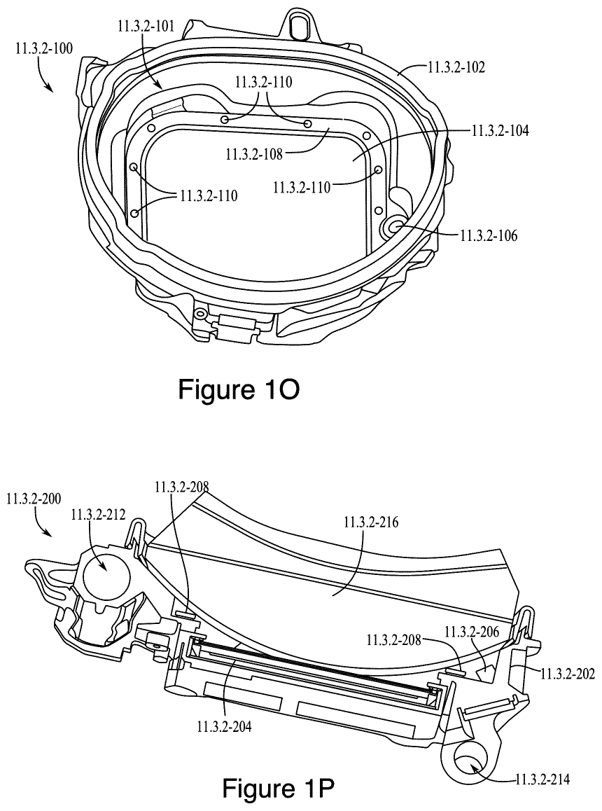

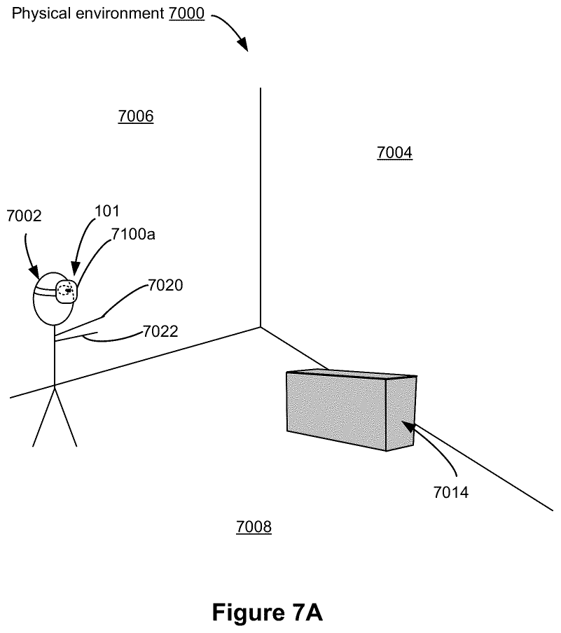

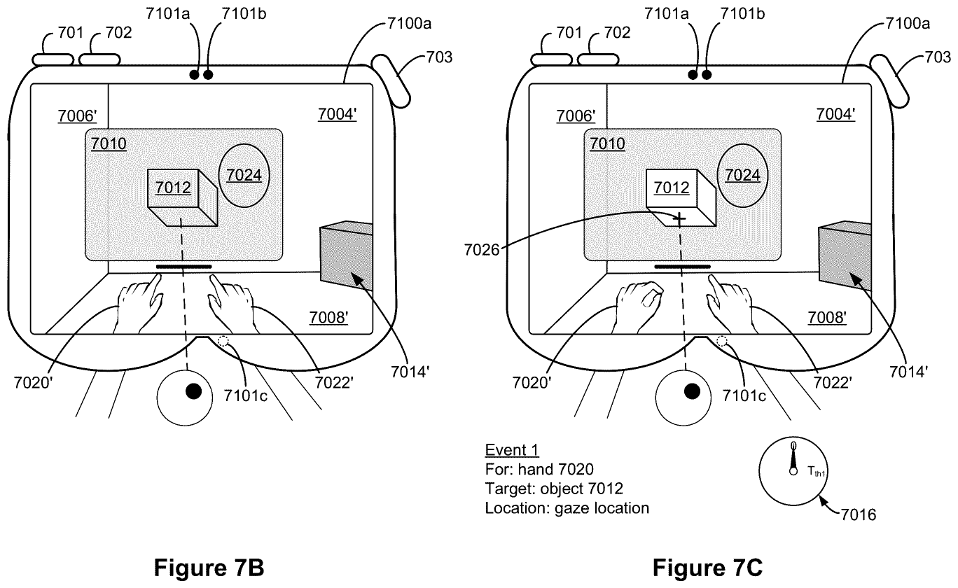

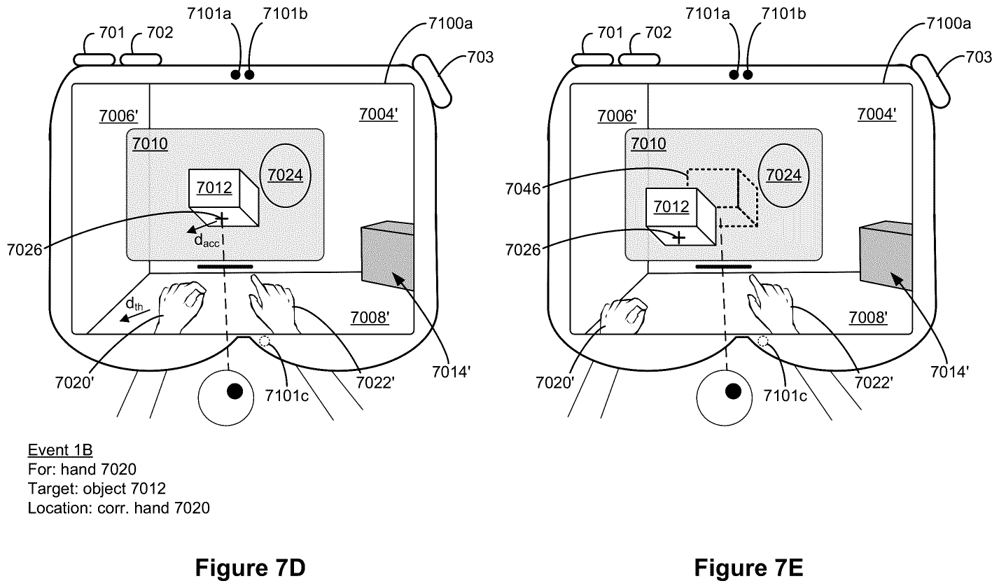

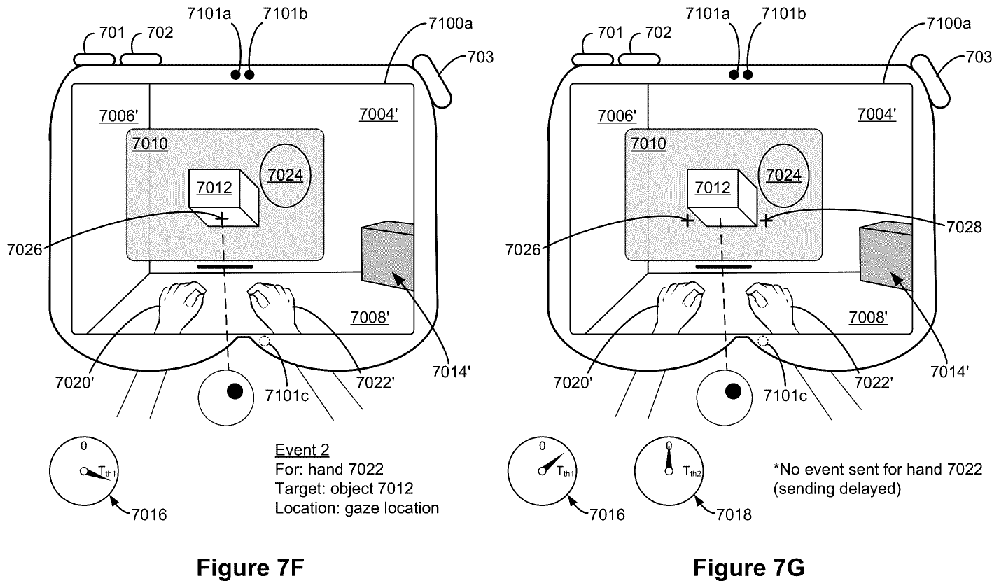

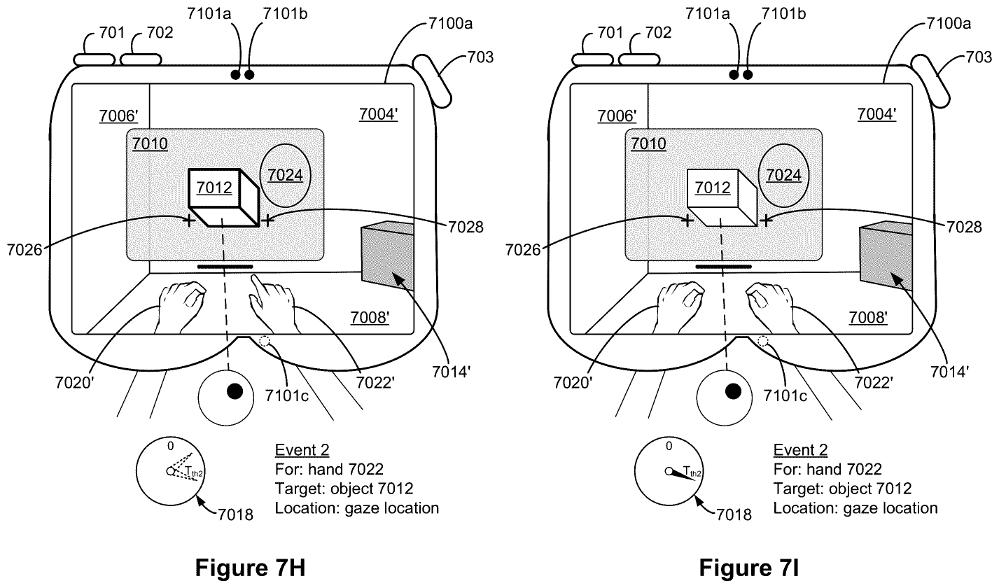

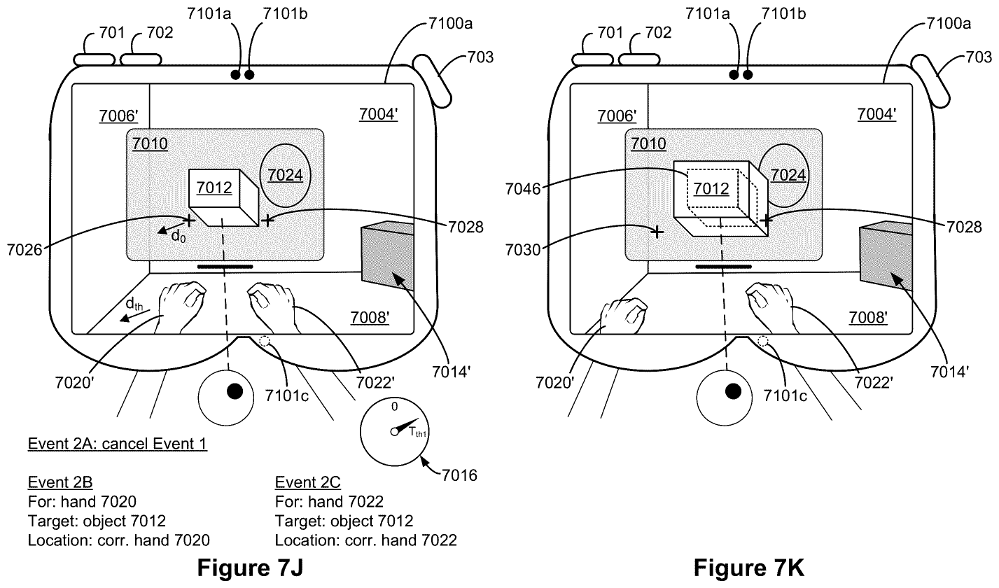

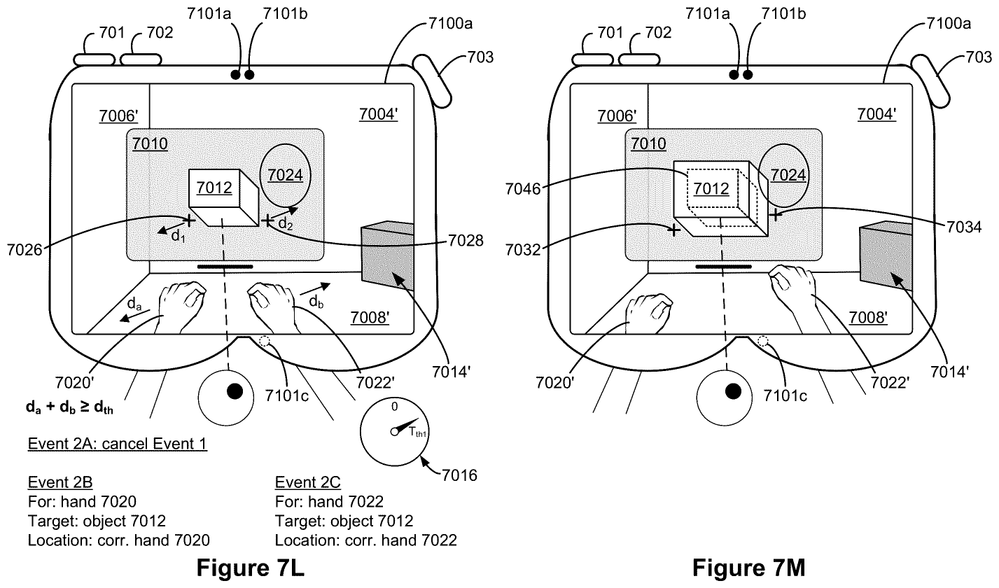

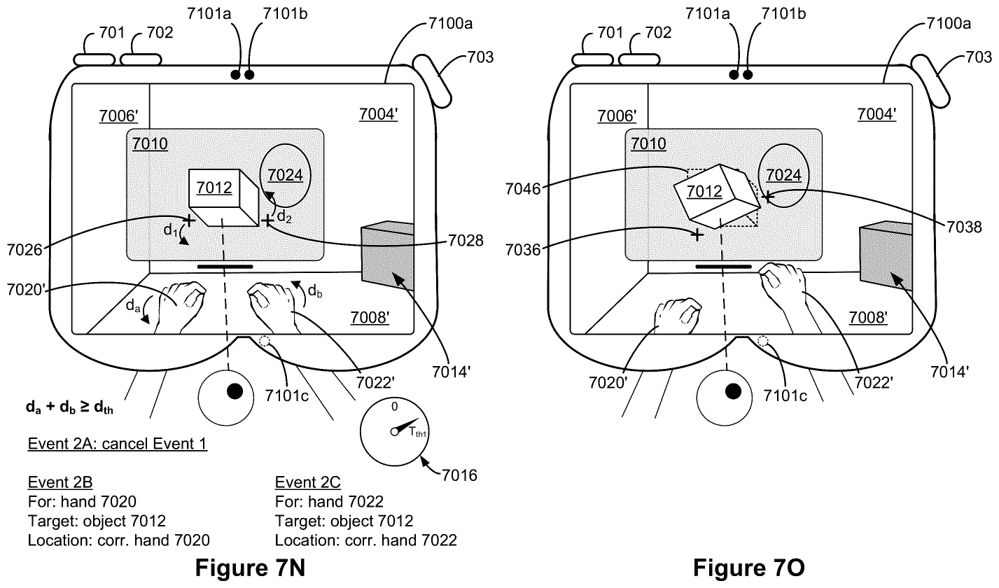

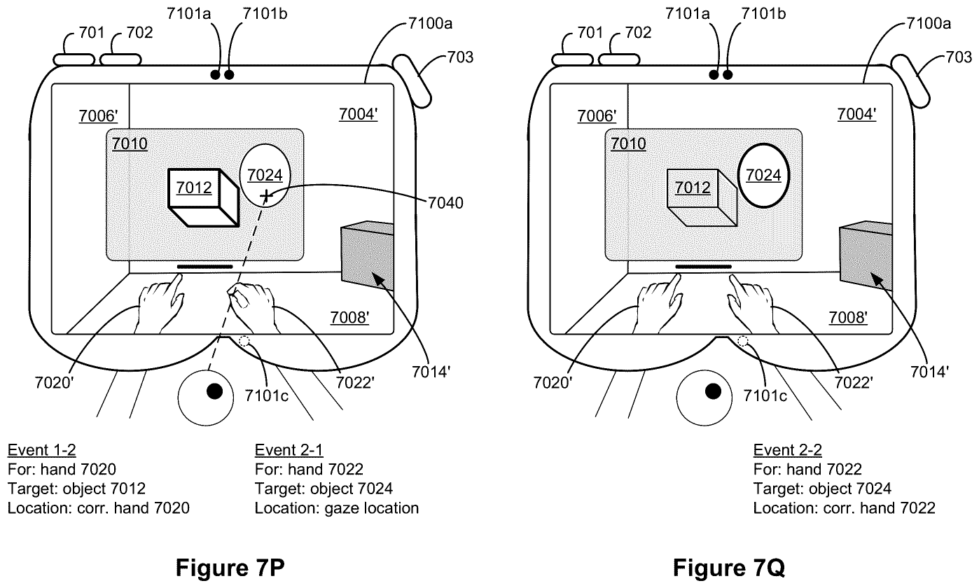

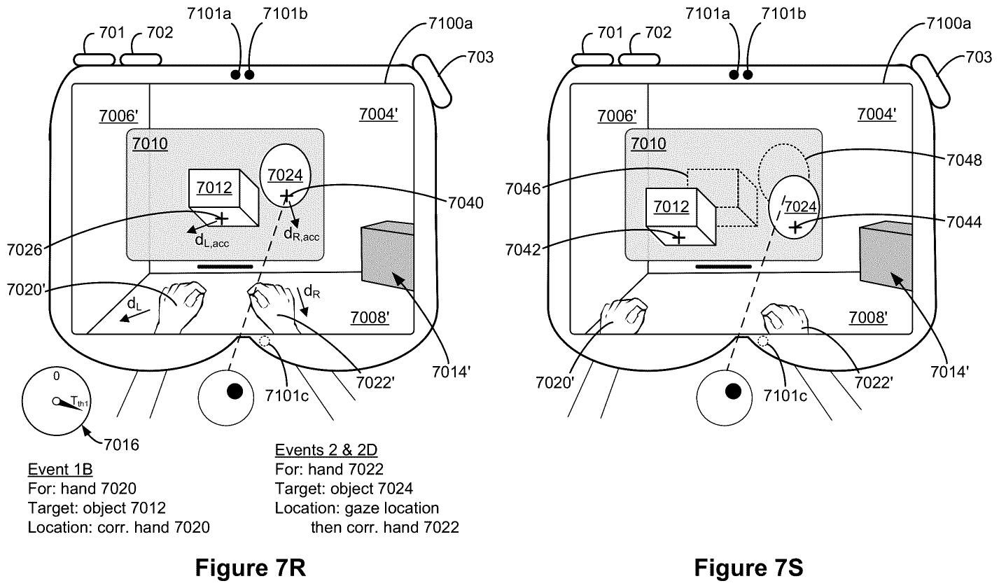

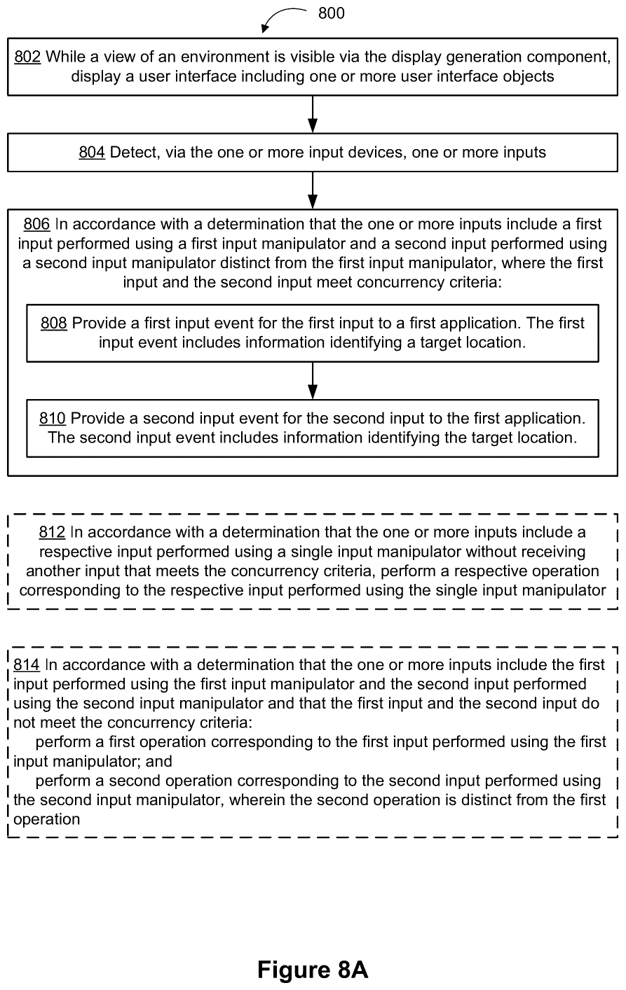

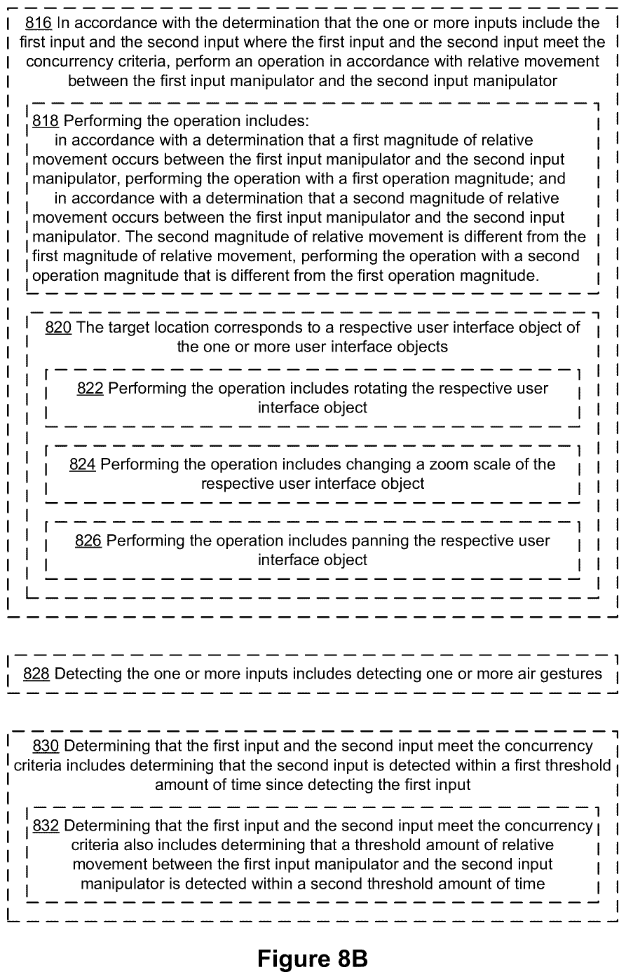

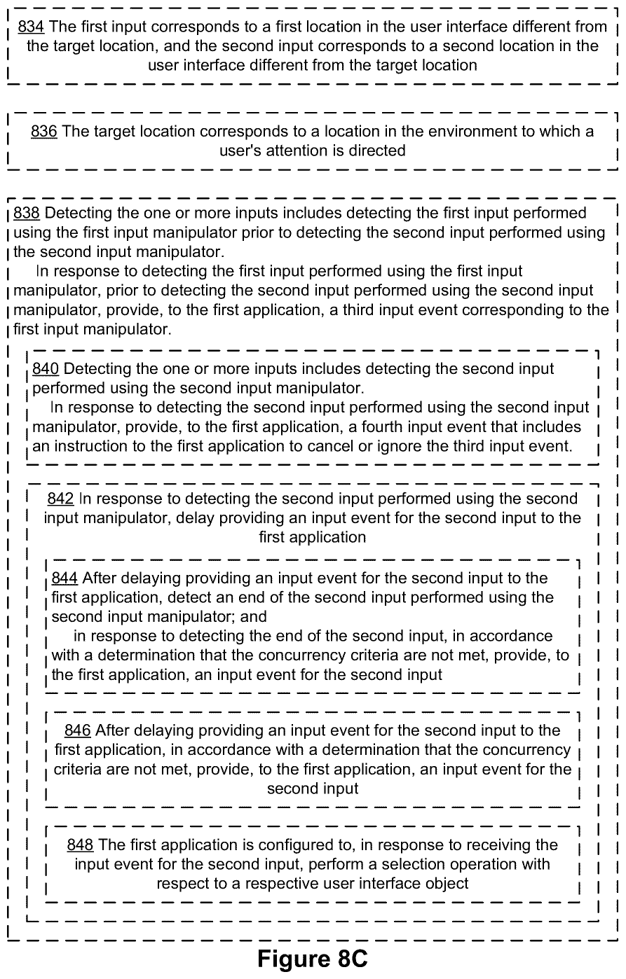

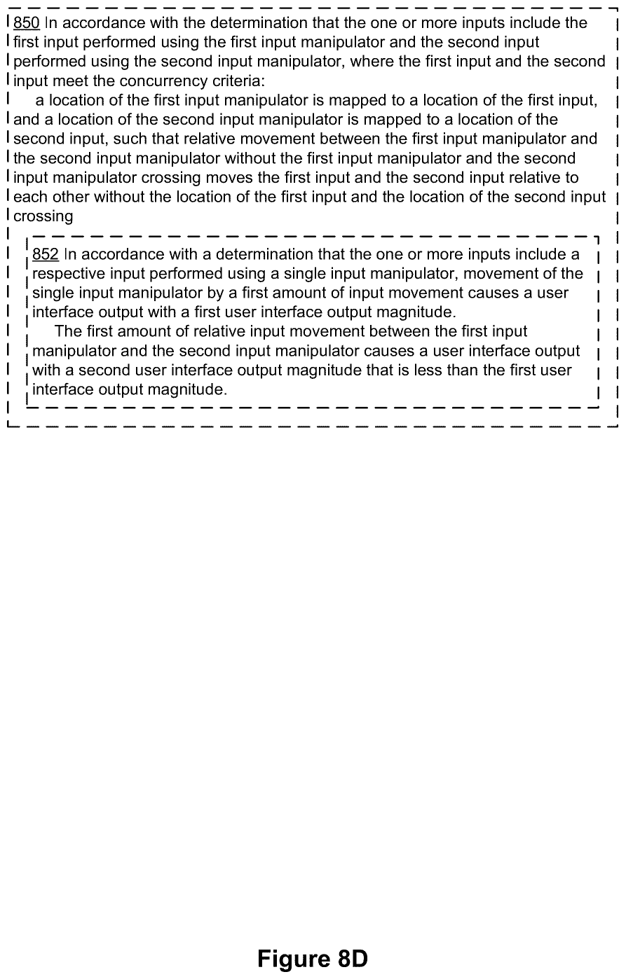

FIGS. 1A-6 provide a description of example computer systems for providing XR experiences to users (such as described below with respect to method 800). FIGS. 7A-7S illustrate example techniques for processing inputs performed using different numbers of input manipulators, in accordance with some embodiments. FIGS. 8A-8D are flow diagrams of methods of processing inputs performed using different numbers of input manipulators, in accordance with various embodiments. The user interfaces in FIGS. 7A-7S are used to illustrate the processes in FIGS. 8A-8D.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, an XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in an XR environment may be made in response to representations of physical motions (e.g., vocal commands). A person may sense and/or interact with an XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location and direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

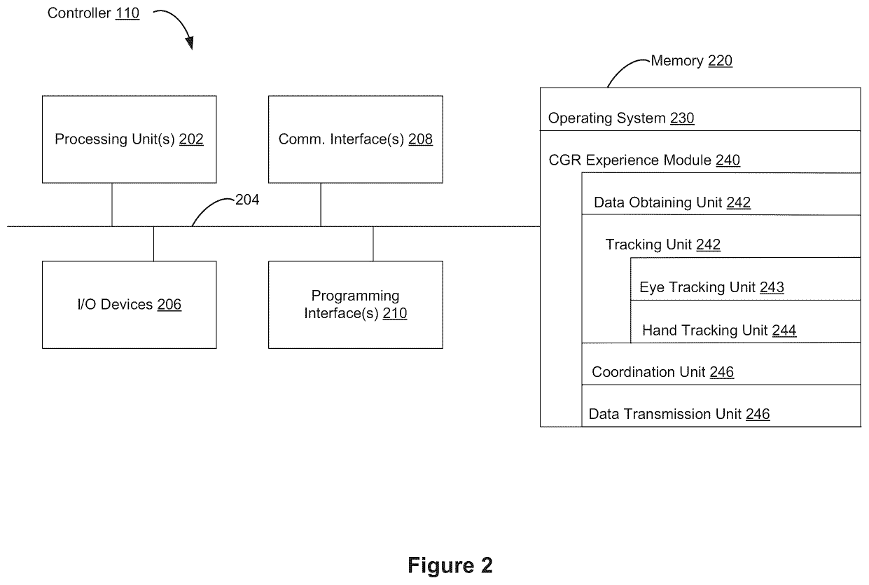

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate an XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

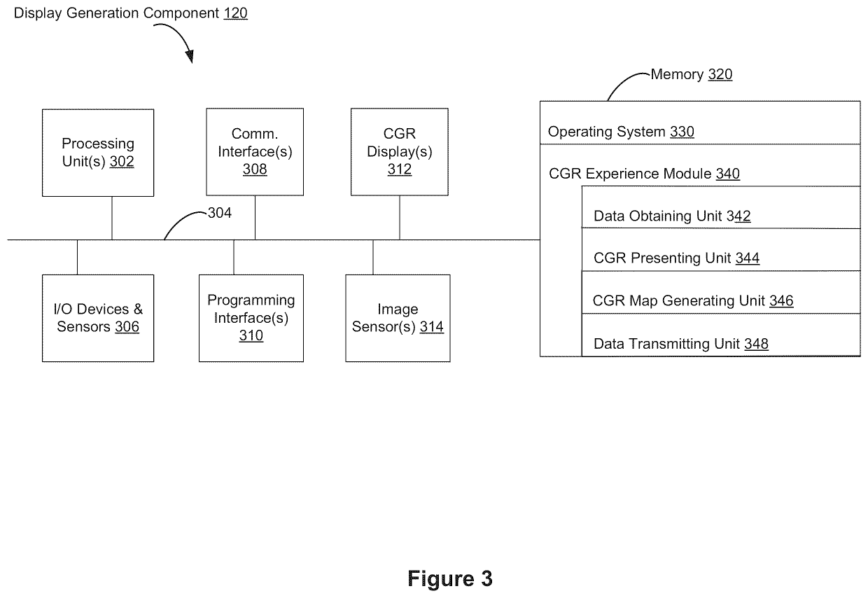

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is an XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in an HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 11) for detecting information about a physical environment of the device which can be used (optionally in conjunction with one or more illuminators such as the illuminators described in FIG. 11) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 11) that can be used (optionally in conjunction with one or more illuminators such as the illuminators 6-124 described in FIG. 11) to determine when one or more air gestures have been performed. In some embodiments, the computer system includes one or more input devices for detecting input such as one or more sensors for detecting eye movement (e.g., eye tracking and gaze tracking sensors in FIG. 11) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of an HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of an HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 11. FIG. 11 shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HMD device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 11 can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 11.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HMD 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 11, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 11 and 1K-1L and described herein. Likewise, any of the features, components, and/or parts, including the arrangements and configurations thereof shown and described with reference to FIGS. 11 and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 11-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HMD devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and an XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 242, a tracking unit 244, a coordination unit 246, and a data transmitting unit 248.

In some embodiments, the data obtaining unit 242 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 242 includes instructions and/or logic therefor, and heuristics and metadata therefor.

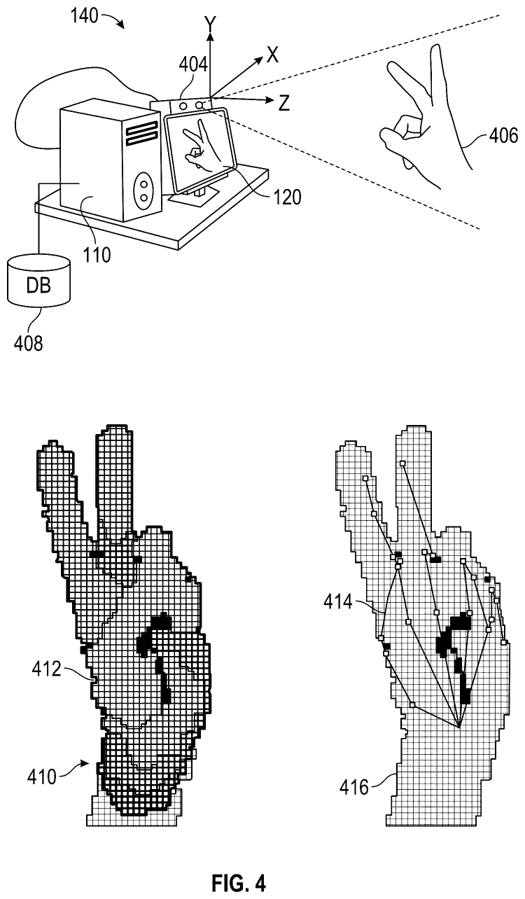

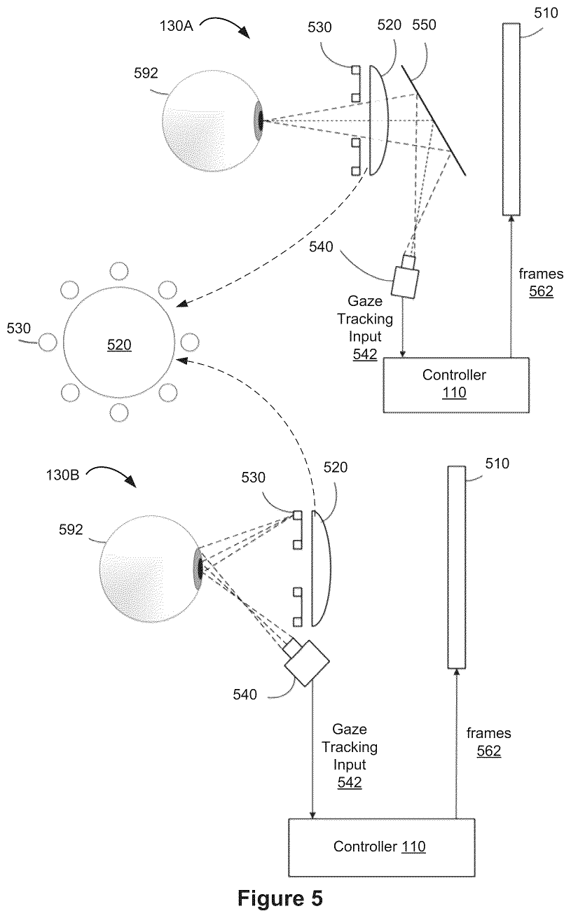

In some embodiments, the tracking unit 244 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 244 includes instructions and/or logic therefor, and heuristics and metadata therefor. In some embodiments, the tracking unit 244 includes hand tracking unit 245 and/or eye tracking unit 243. In some embodiments, the hand tracking unit 245 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 245 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 242, the tracking unit 244 (e.g., including the eye tracking unit 243 and the hand tracking unit 245), the coordination unit 246, and the data transmitting unit 248 are shown as residing on a single device (e.g., the controller 110), it should be understood that in other embodiments, any combination of the data obtaining unit 242, the tracking unit 244 (e.g., including the eye tracking unit 243 and the hand tracking unit 245), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3 is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transistor (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes an XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and an XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, an XR presenting unit 344, an XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate an XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3 is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 4 is a schematic, pictorial illustration of an example embodiment of the hand tracking device 140. In some embodiments, hand tracking device 140 (FIG. 1A) is controlled by hand tracking unit 245 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environment of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving their hand 406 and/or changing their hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves their hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and fingertips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture is performed using a first hand of the user (e.g., a pinch input, a long pinch input, or a pinch and drag input), and, in conjunction with performing the pinch input using the first hand, a second pinch input is performed using the other hand (e.g., the second hand of the user's two hands). In some embodiments, movement between the user's two hands is performed (e.g., to increase and/or decrease a distance or relative orientation between the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, fingertips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or an XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs)), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

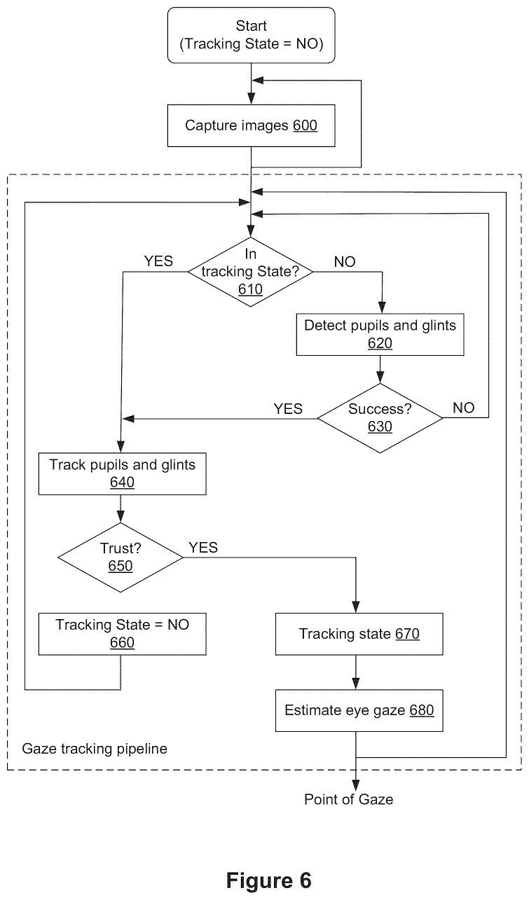

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real-world environment 602 are used to provide a XR experience to the user, for example, a mixed reality environment in which one or more virtual objects are superimposed over representations of real-world environment 602.

Thus, the description herein describes some embodiments of three-dimensional environments (e.g., XR environments) that include representations of real-world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as a portable multifunction device or a head-mounted device, in communication with a display generation component and one or more input devices.

FIGS. 7A-7S include illustrations of three-dimensional environments that are visible via a display generation component (e.g., a display generation component 7100a or a display generation component 120) of a computer system (e.g., computer system 101) and interactions that occur in the three-dimensional environments caused by user inputs directed to the three-dimensional environments and/or inputs received from other computer systems and/or sensors. In some embodiments, an input is directed to a virtual object within a three-dimensional environment by a user's gaze detected in the region occupied by the virtual object, or by a hand gesture performed at a location in the physical environment that corresponds to the region of the virtual object. In some embodiments, an input is directed to a virtual object within a three-dimensional environment by a hand gesture that is performed (e.g., optionally, at a location in the physical environment that is independent of the region of the virtual object in the three-dimensional environment) while the virtual object has input focus (e.g., while the virtual object has been selected by a concurrently and/or previously detected gaze input, selected by a concurrently or previously detected pointer input, and/or selected by a concurrently and/or previously detected gesture input). In some embodiments, an input is directed to a virtual object within a three-dimensional environment by an input device that has positioned a focus selector object (e.g., a pointer object or selector object) at the position of the virtual object. In some embodiments, an input is directed to a virtual object within a three-dimensional environment via other means (e.g., voice and/or control button). In some embodiments, an input is directed to a representation of a physical object or a virtual object that corresponds to a physical object by the user's hand movement (e.g., whole hand movement, whole hand movement in a respective posture, movement of one portion of the user's hand relative to another portion of the hand, and/or relative movement between two hands) and/or manipulation with respect to the physical object (e.g., touching, swiping, tapping, opening, moving toward, and/or moving relative to). In some embodiments, the computer system displays some changes in the three-dimensional environment (e.g., displaying additional virtual content, ceasing to display existing virtual content, and/or transitioning between different levels of immersion with which visual content is being displayed) in accordance with inputs from sensors (e.g., image sensors, temperature sensors, biometric sensors, motion sensors, and/or proximity sensors) and contextual conditions (e.g., location, time, and/or presence of others in the environment). In some embodiments, the computer system displays some changes in the three-dimensional environment (e.g., displaying additional virtual content, ceasing to display existing virtual content, and/or transitioning between different levels of immersion with which visual content is being displayed) in accordance with inputs from other computers used by other users that are sharing the computer-generated environment with the user of the computer system (e.g., in a shared computer-generated experience, in a shared virtual environment, and/or in a shared virtual or augmented reality environment of a communication session). In some embodiments, the computer system displays some changes in the three-dimensional environment (e.g., displaying movement, deformation, and/or changes in visual characteristics of a user interface, a virtual surface, a user interface object, and/or virtual scenery) in accordance with inputs from sensors that detect movement of other persons and objects and movement of the user that may not qualify as a recognized gesture input for triggering an associated operation of the computer system.

In some embodiments, a three-dimensional environment that is visible via a display generation component described herein is a virtual three-dimensional environment that includes virtual objects and content at different virtual positions in the three-dimensional environment without a representation of the physical environment. In some embodiments, the three-dimensional environment is a mixed reality environment that displays virtual objects at different virtual positions in the three-dimensional environment that are constrained by one or more physical aspects of the physical environment (e.g., positions and orientations of walls, floors, surfaces, direction of gravity, time of day, and/or spatial relationships between physical objects). In some embodiments, the three-dimensional environment is an augmented reality environment that includes a representation of the physical environment. In some embodiments, the representation of the physical environment includes respective representations of physical objects and surfaces at different positions in the three-dimensional environment, such that the spatial relationships between the different physical objects and surfaces in the physical environment are reflected by the spatial relationships between the representations of the physical objects and surfaces in the three-dimensional environment. In some embodiments, when virtual objects are placed relative to the positions of the representations of physical objects and surfaces in the three-dimensional environment, they appear to have corresponding spatial relationships with the physical objects and surfaces in the physical environment. In some embodiments, the computer system transitions between displaying the different types of environments (e.g., transitions between presenting a computer-generated environment or experience with different levels of immersion, adjusting the relative prominence of audio/visual sensory inputs from the virtual content and from the representation of the physical environment) based on user inputs and/or contextual conditions.

In some embodiments, the display generation component includes a pass-through portion in which the representation of the physical environment is displayed or visible. In some embodiments, the pass-through portion of the display generation component is a transparent or semi-transparent (e.g., see-through) portion of the display generation component revealing at least a portion of a physical environment surrounding and within the field of view of a user (sometimes called “optical passthrough”). For example, the pass-through portion is a portion of a head-mounted display or heads-up display that is made semi-transparent (e.g., less than 50%, 40%, 30%, 20%, 15%, 10%, or 5% of opacity) or transparent, such that the user can see through it to view the real world surrounding the user without removing the head-mounted display or moving away from the heads-up display. In some embodiments, the pass-through portion gradually transitions from semi-transparent or transparent to fully opaque when displaying a virtual or mixed reality environment. In some embodiments, the pass-through portion of the display generation component displays a live feed of images or video of at least a portion of physical environment captured by one or more cameras (e.g., rear facing camera(s) of a mobile device or associated with a head-mounted display, or other cameras that feed image data to the computer system) (sometimes called “digital passthrough”). In some embodiments, the one or more cameras point at a portion of the physical environment that is directly in front of the user's eyes (e.g., behind the display generation component relative to the user of the display generation component). In some embodiments, the one or more cameras point at a portion of the physical environment that is not directly in front of the user's eyes (e.g., in a different physical environment, or to the side of or behind the user).

In some embodiments, when displaying virtual objects at positions that correspond to locations of one or more physical objects in the physical environment (e.g., at positions in a virtual reality environment, a mixed reality environment, or an augmented reality environment), at least some of the virtual objects are displayed in place of (e.g., replacing display of) a portion of the live view (e.g., a portion of the physical environment captured in the live view) of the cameras. In some embodiments, at least some of the virtual objects and content are projected onto physical surfaces or empty space in the physical environment and are visible through the pass-through portion of the display generation component (e.g., viewable as part of the camera view of the physical environment, or through the transparent or semi-transparent portion of the display generation component). In some embodiments, at least some of the virtual objects and virtual content are displayed to overlay a portion of the display and block the view of at least a portion of the physical environment visible through the transparent or semi-transparent portion of the display generation component.

In some embodiments, the display generation component displays different views of the three-dimensional environment in accordance with user inputs or movements that change the virtual position of the viewpoint of the currently displayed view of the three-dimensional environment relative to the three-dimensional environment. In some embodiments, when the three-dimensional environment is a virtual environment, the viewpoint moves in accordance with navigation or locomotion requests (e.g., in-air hand gestures, and/or gestures performed by movement of one portion of the hand relative to another portion of the hand) without requiring movement of the user's head, torso, and/or the display generation component in the physical environment. In some embodiments, movement of the user's head and/or torso, and/or the movement of the display generation component or other location sensing elements of the computer system (e.g., due to the user holding the display generation component or wearing the HMD), relative to the physical environment, cause corresponding movement of the viewpoint (e.g., with corresponding movement direction, movement distance, movement speed, and/or change in orientation) relative to the three-dimensional environment, resulting in corresponding change in the currently displayed view of the three-dimensional environment. In some embodiments, when a virtual object has a preset spatial relationship relative to the viewpoint (e.g., is anchored or fixed to the viewpoint), movement of the viewpoint relative to the three-dimensional environment would cause movement of the virtual object relative to the three-dimensional environment while the position of the virtual object in the field of view is maintained (e.g., the virtual object is said to be head locked). In some embodiments, a virtual object is body-locked to the user, and moves relative to the three-dimensional environment when the user moves as a whole in the physical environment (e.g., carrying or wearing the display generation component and/or other location sensing component of the computer system), but will not move in the three-dimensional environment in response to the user's head movement alone (e.g., the display generation component and/or other location sensing component of the computer system rotating around a fixed location of the user in the physical environment). In some embodiments, a virtual object is, optionally, locked to another portion of the user, such as a user's hand or a user's wrist, and moves in the three-dimensional environment in accordance with movement of the portion of the user in the physical environment, to maintain a preset spatial relationship between the position of the virtual object and the virtual position of the portion of the user in the three-dimensional environment. In some embodiments, a virtual object is locked to a preset portion of a field of view provided by the display generation component, and moves in the three-dimensional environment in accordance with the movement of the field of view, irrespective of movement of the user that does not cause a change of the field of view.

In some embodiments, the views of a three-dimensional environment sometimes do not include representation(s) of a user's hand(s), arm(s), and/or wrist(s). In some embodiments, as shown in and described herein with reference to FIGS. 7A-7S, the representation(s) of a user's hand(s), arm(s), and/or wrist(s) are included in the views of a three-dimensional environment. In some embodiments, the representation(s) of a user's hand(s), arm(s), and/or wrist(s) are included in the views of a three-dimensional environment as part of the representation of the physical environment provided via the display generation component. In some embodiments, the representations are not part of the representation of the physical environment and are separately captured (e.g., by one or more cameras pointing toward the user's hand(s), arm(s), and wrist(s)) and displayed in the three-dimensional environment independent of the currently displayed view of the three-dimensional environment. In some embodiments, the representation(s) include camera images as captured by one or more cameras of the computer system(s), or stylized versions of the arm(s), wrist(s) and/or hand(s) based on information captured by various sensors). In some embodiments, the representation(s) replace display of, are overlaid on, or block the view of, a portion of the representation of the physical environment. In some embodiments, when the display generation component does not provide a view of a physical environment, and provides a completely virtual environment (e.g., no camera view and no transparent pass-through portion), real-time visual representations (e.g., stylized representations or segmented camera images) of one or both arms, wrists, and/or hands of the user are, optionally, still displayed in the virtual environment. In some embodiments, if a representation of the user's hand is not provided in the view of the three-dimensional environment, the position that corresponds to the user's hand is optionally indicated in the three-dimensional environment, e.g., by the changing appearance of the virtual content (e.g., through a change in translucency and/or simulated reflective index) at positions in the three-dimensional environment that correspond to the location of the user's hand in the physical environment. In some embodiments, the representation of the user's hand or wrist is outside of the currently displayed view of the three-dimensional environment while the virtual position in the three-dimensional environment that corresponds to the location of the user's hand or wrist is outside of the current field of view provided via the display generation component; and the representation of the user's hand or wrist is made visible in the view of the three-dimensional environment in response to the virtual position that corresponds to the location of the user's hand or wrist being moved within the current field of view due to movement of the display generation component, the user's hand or wrist, the user's head, and/or the user as a whole.

FIGS. 7A-7S illustrate examples of processing inputs performed using different numbers of input manipulators.

FIG. 7A illustrates an example physical environment 7000 that includes a user 7002 interacting with a computer system 101. Computer system 101 is worn on user 7002's head and typically positioned in front of user 7002. In FIG. 7A, user 7002's left hand 7020 and right hand 7022 are free to interact with computer system 101. Physical environment 7000 includes a physical object 7014, physical walls 7004 and 7006, and a physical floor 7008. As shown in the examples in FIGS. 7B-7S, display generation component 7100a of computer system 101 is a head-mounted display (HMD) worn on user 7002's head (e.g., what is shown in FIGS. 7A-7S as being visible via display generation component 7100a of computer system 101 corresponds to user 7002's view of an environment when wearing a head-mounted display).

In some embodiments, the head mounted display (HMD) 7100a includes one or more displays that display a representation of a portion of the three-dimensional environment 7000′ that corresponds to the perspective of the user. While an HMD typically includes multiple displays including a display for a right eye and a separate display for a left eye that display slightly different images to generate user interfaces with stereoscopic depth, in FIGS. 7B-7S, a single image is shown that corresponds to the image for a single eye and depth information is indicated with other annotations or description of the figures. In some embodiments, HMD 7100a includes one or more sensors (e.g., one or more interior- and/or exterior-facing image sensors 314), such as sensor 7101a, sensor 7101b and/or sensor 7101c (FIG. 7B) for detecting a state of the user, including facial and/or eye tracking of the user (e.g., using one or more inward-facing sensors 7101a and/or 7101b) and/or tracking hand, torso, or other movements of the user (e.g., using one or more outward-facing sensors 7101c). In some embodiments, HMD 7100a includes one or more input devices that are optionally located on a housing of HMD 7100a, such as one or more buttons, trackpads, touchscreens, scroll wheels, digital crowns that are rotatable and depressible or other input devices. In some embodiments input elements are mechanical input elements, in some embodiments input elements are solid state input elements that respond to press inputs based on detected pressure or intensity. For example, in FIGS. 7B-7S, HMD 7100a includes one or more of button 701, button 702 and digital crown 703 for providing inputs to HMD 7100a. It will be understood that additional and/or alternative input devices may be included in HMD 7100a.

In some embodiments, the display generation component of computer system 101 is a touchscreen held by user 7002. In some embodiments, the display generation component is a standalone display, a projector, or another type of display. In some embodiments, the computer system is in communication with one or more input devices, including cameras or other sensors and input devices that detect movement of the user's hand(s), movement of the user's body as whole, and/or movement of the user's head in the physical environment. In some embodiments, the one or more input devices detect the movement and the current postures, orientations, and positions of the user's hand(s), face, and/or body as a whole. For example, in some embodiments, while the user's hand 7020 (e.g., a left hand) is within the field of view of the one or more sensors of HMD 7100a (e.g., within the field of view of the user), a representation of the user's hand 7020′ is displayed in the user interface displayed (e.g., as a passthrough representation and/or as a virtual representation of the user's hand 7020) on the display of HMD 7100a. In some embodiments, while the user's hand 7022 (e.g., a right hand) is within the field of view of the one or more sensors of HMD 7100a (e.g., within the field of view of the user), a representation of the user's hand 7022′ is displayed in the user interface displayed (e.g., as a passthrough representation and/or as a virtual representation of the user's hand 7022) on the display of HMD 7100a. In some embodiments, the user's hand 7020 and/or the user's hand 7022 are used to perform one or more gestures (e.g., one or more air gestures), optionally in combination with a gaze input. In some embodiments, the one or more gestures performed with the user's hand(s) 7020 and/or 7022 include a direct air gesture input that is based on a position of the representation of the user's hand(s) 7020′ and/or 7022′ displayed within the user interface on the display of HMD 7100a. For example, a direct air gesture input is determined as being directed to a user interface object displayed at a position that intersects with the displayed position of the representation of the user's hand(s) 7020′ and/or 7022′ in the user interface. In some embodiments, the one or more gestures performed with the user's hand(s) 7020 and/or 7022 include an indirect air gesture input that is based on a virtual object displayed at a position that corresponds a position at which the user's attention is currently detected (e.g., and/or is optionally not based on a position of the representation of the user's hand(s) 7020′ and/or 7022′ displayed within the user interface). For example, an indirect air gesture is performed with respect to a user interface object while detecting the user's attention (e.g., based on gaze or other indication of user attention) on the user interface object, such as a gaze and pinch (e.g., or other gesture performed with the user's hand).

In some embodiments, user inputs are detected via a touch-sensitive surface or touchscreen. In some embodiments, the one or more input devices include an eye tracking component that detects location and movement of the user's gaze. In some embodiments, the display generation component, and optionally, the one or more input devices and the computer system, are parts of a head-mounted device that moves and rotates with the user's head in the physical environment, and changes the viewpoint of the user in the three-dimensional environment provided via the display generation component. In some embodiments, the display generation component is a heads-up display that does not move or rotate with the user's head or the user's body as a whole, but, optionally, changes the viewpoint of the user in the three-dimensional environment in accordance with the movement of the user's head or body relative to the display generation component. In some embodiments, the display generation component (e.g., a touchscreen) is optionally moved and rotated by the user's hand relative to the physical environment or relative to the user's head, and changes the viewpoint of the user in the three-dimensional environment in accordance with the movement of the display generation component relative to the user's head or face or relative to the physical environment.

In some embodiments, one or more portions of the view of physical environment 7000 that is visible to user 7002 via display generation component 7100a are digital passthrough portions that include representations of corresponding portions of physical environment 7000 captured via one or more image sensors of computer system 101. In some embodiments, one or more portions of the view of physical environment 7000 that is visible to user 7002 via display generation component 7100a are optical passthrough portions, in that user 7002 can see one or more portions of physical environment 7000 through one or more transparent or semi-transparent portions of display generation component 7100a.

In some embodiments, the computer system is configured to process inputs such as the inputs described herein with reference to FIGS. 7A-7S as simulated touch inputs or other simulated inputs. For example, for inputs described herein with reference to FIGS. 7A-7S that are detected as air gestures (e.g., involving detecting the location and/or movement of the user's gaze and/or hand) rather than as other types of inputs (e.g., touch inputs, mouse inputs, keyboard inputs, etc.), information about the air gesture inputs is optionally provided using an input processing framework for processing other types of inputs, such as by describing the air gesture inputs using input events and data structures for other types of inputs. Using a system-provided framework, such as an application programming interface (API), that translates other types of user inputs, such as air gestures, into simulated inputs of other types allows applications that were designed for other types of interaction such as touch interaction or interactions with a mouse and keyboard to be able to receive and process the other types of user inputs, without requiring the applications to be redesigned and redeployed.

When using touch-based inputs via a touch-sensitive surface to control software running on a computer system, touch inputs have both temporal and spatial aspects. The temporal aspects include the phase of a touch input, which indicates when a touch has just begun, whether it is moving or stationary, and when it ends (e.g., when the finger providing the touch input is lifted away from the touch-sensitive surface). The spatial aspects of a touch input include the location in the user interface and/or the set of one or more user interface regions or user interface windows in which the touch input occurs. In an example touch input processing framework, touch inputs that are detected as one or more touch input signals via a touch-sensitive surface are represented by one or more input events (e.g., touch events) that describe the temporal and spatial aspects of the touch inputs. For example, a respective touch input via a touch-sensitive surface is optionally represented by a sequence of input events (e.g., touch events), and in some embodiments multiple concurrent touch inputs via the touch-sensitive surface are represented by a sequence of input events (e.g., touch events) (e.g., where each input event (e.g., touch event) describes corresponding portions of multiple concurrent touch inputs) or by respective sequences of input events (e.g., touch events) (e.g., where each input event (e.g., touch event) describes a distinct portion of a distinct touch input). A respective input event (e.g., touch event) thus describes a respective portion of a current or recent touch input, or of multiple concurrent touch inputs (in which case information about multiple concurrent touch inputs is optionally arranged into one or more lists). Example information in a respective input event (e.g., touch event) that describes a respective touch input on or near a touch-sensitive surface includes the following, or a subset or superset thereof:
an input identifier identifying the input (e.g., in some embodiments the input identifier for an input is the same for all input events (e.g., touch events) that are associated with the same input);
a time stamp for the input event (e.g., a time stamp of the corresponding portion of the input);
a location of the input, for example relative to an input element such as a touch-sensitive surface (e.g., using two-dimensional coordinates or in some cases three-dimensional coordinates, where a third coordinate represents a distance relative to the input element and is optionally used to describe how far a hover input is above the input element);
a target of the input (e.g., identifying one or more user interface regions and/or user interface windows in which the input occurs or to which the input is directed);
a duration of the input (e.g., since initial detection of the input with this input event's input identifier);
a direction and/or speed of movement of the input; and/or
a phase value that indicates a current phase of the input. The following are examples of phase values:
   hover begin (e.g., indicating a beginning of an input proximate to but not in contact with the touch-sensitive surface);
   hover stationary (e.g., indicating that an already-detected hover input is ongoing, without the input coming into contact with the touch-sensitive surface, and without a change in proximity or location);
   hover changed (e.g., indicating an update to proximity or location of an already-detected hover input, without the input coming into contact with the touch-sensitive surface);
   hover end (e.g., indicating that a touch input is no longer detected proximate to nor in contact with the touch-sensitive surface, such as when the hover input has moved out of detection range of the touch-sensitive surface);
   input begin (e.g., indicating an initial contact with a touch-sensitive surface, such as by a touch input that was previously in a hover phase coming into contact with the touch-sensitive surface; or indicating a beginning of a non-contact input);
   input stationary (e.g., indicating that an already-detected contact is ongoing and has not moved along the touch-sensitive surface; or indicating that an already-detected non-contact input is ongoing and has not moved);
   input changed (e.g., indicating an update to the location of an already-detected contact with the touch-sensitive surface; or indicating an update to the location of an already-detected non-contact input);
   input end (e.g., indicating that a contact with the touch-sensitive surface has ceased to be detected on the touch-sensitive surface, such as by liftoff of the contact from the touch-sensitive surface as part of ending a touch gesture or that an input has otherwise ended; or indicating that a termination of an already-detected non-contact input); and/or
   input cancel (e.g., indicating that an input has been determined to be an accidental input or has been otherwise identified as an input that should be ignored, and that an application performing an operation based on the input should cancel the operation, such as by reverting to a state before the input was detected).

In some embodiments, the information in the input event includes information identifying a target location (e.g., coordinate(s) of the target location, an identifier of an object corresponding to the target location, etc.). In some embodiments, the information in the input event includes the information identifying the target location (e.g., coordinates) in addition to the target of the input. In some embodiments, the information identifying the target location is included in, or derivable from, the information identifying the target of the input.

In some embodiments, input events for inputs such as the user inputs by hand 7020 and/or hand 7022 described herein with reference to FIGS. 7A-7S are provided in the form of other types of input events (e.g., touch events) so that the user inputs (e.g., even if performed as air gestures and not as touch inputs) are processed as other types of inputs (e.g., simulated touch inputs, simulated mouse and/or keyboard inputs, or other type of inputs). Thus, in some embodiments, the respective input event includes information that describes a touch input that corresponds to, or simulates, the input event. For example, in some embodiments, the respective input event includes the following, or a subset or superset thereof: a touch identifier identifying the touch input, a time stamp for the touch event, a location of the touch input relative to the touch-sensitive surface, a target of the touch input, a duration of the touch input, a direction and/or speed of movement of the touch input, and/or a phase value that indicates a current phase of the touch input, such as touch begin, touch stationary, touch changed, touch end, and touch cancel.

In some embodiments, inputs such as the inputs described herein with reference to FIGS. 7A-7S are processed using one or more gesture recognizers that are configured to monitor the progression of the inputs and determine whether an input matches the definition of a respective gesture that the computer system is configured to recognize. In some embodiments, a gesture recognizer transitions between one or more states from a plurality of states including “possible,” “active,” “ended,” “canceled,” “failed,” and/or others based on gesture information that is received (e.g., as one or more input events or one or more touch events) or otherwise obtained about a respective input. For example, a selection input, such as a tap gesture, causes a tap gesture recognizer to transition from the “possible” state to the “ended” state (e.g., when performance of a tap gesture, such as by performance of an air pinch or air tap gesture, has been recognized). In another example, a scrolling input causes a scroll gesture recognizer to transition from the “possible” state to the “active” state (during the scrolling, such as while an air pinch is being moved laterally while the fingers performing the air pinch are kept in contact, or while an air tap is being moved laterally while the finger performing the air tap is kept down) to the “ended” state (when the scrolling input has ended, such as when the air pinch is released by separating the fingers or when the air tap is released by lifting the finger) (e.g., the “active” and “ended” both indicate that a gesture has been recognized). In some embodiments, a gesture recognizer remains in the “possible” state during hover phase events (e.g., while a user is indicating readiness to interact yet has not performed a part of an interaction input that would determine whether the input can be recognized as a particular gesture or a part thereof or whether the input cannot be recognized as the particular gesture). In some embodiments, a gesture recognizer transitions to the “canceled” state in response to a “hover cancel,” “input cancel,” or “touch cancel” event. In some embodiments, a gesture recognizer that is configured to recognize a particular gesture transitions to the “failed” state in response to certain input events that make it impossible for the input to be recognized as the particular gesture (e.g., input movement causes a long press gesture recognizer to fail; an input that has continued for more than a threshold amount of time causes a tap gesture recognizer to fail whereas an input that ends too soon causes a long press gesture recognizer to fail; an input that ends without movement causes a scroll gesture recognizer to fail). In some embodiments, the gesture recognizers are part of a system-provided framework, such as an application programming interface (API), that handles input recognition, optionally in addition to translating certain types of user inputs, such as air gestures, into other types of inputs, such as touch inputs or mouse inputs.

FIG. 7B illustrates a view of a three-dimensional environment (e.g., corresponding at least partially to physical environment 7000 in FIG. 7A) that is visible to user 7002 via display generation component 7100a (also called herein “HMD 7100a”) of computer system 101. The three-dimensional environment of FIG. 7B optionally includes representations of objects in a physical environment such as physical environment 7000 (e.g., as captured by one or more cameras of computer system 101). For example, in FIG. 7B, the three-dimensional environment includes representation 7014′ of physical object 7014, representations 7004′ and 7006′ of physical walls 7004 and 7006, respectively, and representation 7008′ of physical floor 7008. In addition, the three-dimensional environment includes one or more computer-generated objects, also called virtual objects, such application user interface 7010 and objects 7012 and 7024 in user interface 7010 (e.g., which are not representations of physical objects in physical environment 7000). In some embodiments, application user interface 7010 corresponds to a user interface of a software application executing on computer system 101 (e.g., an email application, a web browser, a messaging application, a maps application, or other software application). FIG. 7B also shows that representation 7020′ of user 7002's left hand 7020 and representation 7022′ of user 7002's right hand 7022 are visible in the three-dimensional environment via HMD 7100a and are poised to provide input (e.g., in a ready state).

FIG. 7C illustrates an example transition from FIG. 7B. FIG. 7C illustrates a user input that includes hand 7020 (e.g., visible via HMD 7100a (e.g., within the viewport into the three-dimensional environment) as representation 7020′ of the user's hand 7020) performing at least a first portion of an air pinch gesture (also called herein a “first air pinch gesture”) (e.g., including bringing two fingers into contact) while user 7002's attention is directed to (e.g., based on user 7002 gazing at) object 7012 in user interface 7010. Based on user 7002's gaze location when the air pinch gesture by hand 7020 is detected, object 7012 is determined to be the target of the user input. In response to detecting the air pinch gesture performed by hand 7020, computer system 101 delivers an input event (e.g., “Event 1”) to an application (or in some embodiments system software) associated with target object 7012 (or associated more generally with user interface 7010, which includes target object 7012). In some embodiments, the input event “Event 1” includes information identifying the location of user 7002's gaze as a current location of the detected user input. Optionally, as shown in FIG. 7C, object 7012 is visually emphasized in appearance (e.g., highlighted and/or other visual emphasis associated with object targeting) to indicate that object 7012 is a current input target. FIG. 7C also shows timer 7016 being initiated upon detection of the air pinch gesture by hand 7020.

FIGS. 7D-7E illustrate an example transition from FIG. 7C involving performing an operation in the three-dimensional environment using a single input manipulator (e.g., hand 7020). In FIG. 7D, hand 7020 has moved by a threshold distance dₜₕ downward and to the left, relative to the position of hand 7020 in FIG. 7C, while maintaining the air pinch gesture. In response, computer system 101 delivers to the application associated with target object 7012 a subsequent input event (e.g., “Event 1B”) with information identifying a location corresponding to hand 7020 as a location of the input (e.g., after hand 7020 has moved by the threshold distance dₜₕ to the position of hand 7020 shown in FIG. 7E). Thus, in some embodiments, although the input location is initially determined based on the location in the three-dimensional environment to which user 7002's gaze is directed when the first air pinch gesture is detected, the input location is subsequently determined based on the current location of hand 7020 and/or an amount of movement of hand 7020 since detection of the first air pinch gesture. In some embodiments, the amount of movement dₜₕ of hand 7020 corresponds to a magnitude of movement d_{acc} of the input location. In some embodiments, the input movement magnitude is accelerated (e.g., scaled linearly (e.g., using a multiplier) or non-linearly (e.g., using a non-linear function that is based on an amount or speed of input manipulator movement)) relative to the amount of movement of hand 7020 (e.g., d_{acc}>dₜₕ).

In FIG. 7E, in response to the input event “Event 1B” indicating the movement of hand 7020 by the distance dₜₕ to the location of hand 7020 shown in FIG. 7E, computer system 101 (e.g., more specifically, the application associated with user interface 7010) moves object 7012 in user interface 7010 (e.g., away from the prior position of object 7012 as shown in FIG. 7D and indicated by dotted outline 7046 in user interface 7010 in FIG. 7E) by a corresponding (and optionally accelerated) amount d_{acc} of movement of the input location. Accordingly, FIGS. 7D-7E illustrate an operation performed in the three-dimensional environment using a single input manipulator (e.g., hand 7020).

FIG. 7F illustrates an alternative transition from FIG. 7C in which a second air pinch gesture performed by hand 7022 (e.g., visible via HMD 7100a (e.g., within the viewport into the three-dimensional environment) as representation 7022′ of the user's hand 7022) is detected after timer 7016 has elapsed, indicating that more than a threshold amount of time Tₜₕ₁ (also called herein a “first threshold amount of time”) has elapsed since detection of the first air pinch gesture by hand 7020. The user input by hand 7020 and the user input by hand 7022 do not meet concurrency criteria, because the two user inputs were not detected within the threshold amount of time Tₜₕ₁ of each other (e.g., even though the user inputs may meet other requirements for the concurrency criteria, such as being directed to the same gaze location in object 7012 and/or at least partially overlapping in time). Because the two user inputs do not meet the concurrency criteria, computer system 101 delivers an input event (e.g., “Event 2”) for the user input by hand 7022. Input event “Event 2” is delivered to the application associated with object 7012, the target of the user input by hand 7022 as determined based on the location of user 7002's gaze when the second air pinch gesture by hand 7022 is detected, and optionally includes information identifying the location of user 7002's gaze as a current location 7026 of the user input by hand 7022. Thus, in the scenario of FIG. 7F, at least one input event, “Event 1” of FIG. 7C, identifying user 7002's gaze location as the input location, has been delivered to the application associated with user interface 7010 for the user input by hand 7020 (e.g., as described herein with reference to FIG. 7C), and at least one input event, “Event 2” of FIG. 7F, identifying user 7002's gaze location as the input location, has been delivered to the application associated with user interface 7010 for the user input by hand 7022 (e.g., due to failing to meet the concurrency criteria, the user input by hand 7020 and the user input by hand 7022 are processed as distinct inputs using distinct input manipulators yet coincidentally having the same input location).

FIG. 7G illustrates another alternative transition from FIG. 7C in which a second air pinch gesture performed by hand 7022 is detected before timer 7016 has elapsed, indicating that less than the threshold amount of time Tₜₕ₁ has elapsed since detection of the first air pinch gesture by hand 7020. FIG. 7G indicates location 7026 in the three-dimensional environment that corresponds to the current location of hand 7020 in physical space, and location 7028 in the three-dimensional environment that corresponds to the current location of hand 7022 in physical space, where location 7026 and location 7028 are different. However, in the example of FIG. 7G, the user inputs by hand 7020 and hand 7022 have not yet met the concurrency criteria because hand 7020 and hand 7022 have not moved (e.g., by at least the threshold distance dₜₕ relative to each other), although it is still possible for the user inputs by hand 7020 and hand 7022 to meet the concurrency criteria. Accordingly, computer system 101 delays delivering an input event for the user input by hand 7022, optionally until the user inputs by hands 7020 and 7022 meet the concurrency criteria or until it is no longer possible for the user inputs by hands 7020 and 7022 to meet the concurrency criteria (e.g., due to one or more threshold amounts of time elapsing without the concurrency criteria being met). FIG. 7G also shows timer 7018 being initiated upon detection of the second air pinch gesture by hand 7022.

FIG. 7H illustrates an example transition from FIG. 7G in which hand 7022 completes the second air pinch gesture (e.g., by breaking contact between the fingers that were in contact with each other during the second air pinch gesture), thus ending the user input by hand 7022. In the example of FIG. 7H, the user input by hand 7020 (e.g., which continues because hand 7020 is maintaining the first air pinch gesture) and the user input by hand 7022 have failed to meet the concurrency criteria, because the user input by hand 7022 ended without hand 7020 and hand 7022 moving relative to each other by at least the threshold amount of movement dₜₕ (e.g., the threshold amount of movement dₜₕ by hand 7020 while hand 7022 is held still, the threshold amount of movement dₜₕ by hand 7022 while hand 7020 is held still, or movement by both hand 7020 and hand 7022 that totals the threshold amount of movement dₜₕ). In response to detecting the end of the second air pinch gesture by hand 7022, computer system 101 delivers an input event (e.g., “Event 2”) for the end of the user input by hand 7022 (e.g., after having initially delayed the sending of an input event corresponding to the second air pinch gesture by hand 7022, as described herein with reference to FIG. 7G), to the application associated with object 7012, the target of the user input by hand 7022.

The input event “Event 2” in FIG. 7H optionally includes information identifying a location of the input. In some embodiments, the location of the input is initially determined based on the location in the three-dimensional environment to which user 7002's gaze is directed when the second air pinch gesture is detected, and subsequently determined based on the current location of hand 7022 and/or an amount of movement of hand 7022 since detection of the second air pinch gesture. In FIG. 7H, location 7026 corresponding to the location of hand 7020 and location 7028 corresponding to the location of hand 7022 are the same as in FIG. 7G, because hand 7020 has not moved since initiating the first air pinch gesture, and hand 7022 has not moved since initiating the second air pinch gesture. User 7002's gaze has also not moved since the second air pinch gesture was initiated. Accordingly, the input location included in input event “Event 2” in FIG. 7H for the user input performed by hand 7022 coincides with user 7002's gaze location, whether the input location is based on the location of user 7002's gaze or based on the location and/or movement of hand 7022, because neither user 7002's gaze nor hand 7022 has moved since the second air pinch gesture was initiated.

FIG. 7H also illustrates that in some embodiments, the input event “Event 2” is delivered in response to detecting the end of the user input by hand 7022 without regard to whether timer 7018 has elapsed, and thus without regard to whether a second threshold amount of time Tₜₕ₂ has elapsed since detection of the second air pinch gesture by hand 7022. Thus, in the scenario of FIG. 7H, at least one input event, “Event 1” of FIG. 7C, identifying user 7002's gaze location as the input location, has been delivered to the application associated with user interface 7010 for the user input by hand 7020 (e.g., as described herein with reference to FIG. 7C), and at least one input event, “Event 2” of FIG. 7H, identifying user 7002's gaze location as the input location, has been delivered to the application associated with user interface 7010 for the user input by hand 7022 (e.g., the user input by hand 7020 and the user input by hand 7022 are processed as distinct inputs using distinct input manipulators due to failing to meet the concurrency criteria).

In response to the input event “Event 2” of FIG. 7H indicating the end of the user input by hand 7022 directed to target object 7012, computer system 101 (e.g., more specifically, the application associated with user interface 7010) performs a selection operation with respect to object 7012, for example by displaying object 7012 with an appearance indicating that object 7012 is selected (e.g., with highlighting, a selection outline, and/or other visual emphasis associated with object selection).

FIG. 7I illustrates an alternative transition from FIG. 7G in which hand 7022 is maintaining the second air pinch gesture while hand 7020 is maintaining the first air pinch gesture, and timer 7018 has elapsed, indicating that the second threshold amount of time Tₜₕ₂ has elapsed since detection of the second air pinch gesture by hand 7022. In FIG. 7I, location 7026 corresponding to the location of hand 7020 and location 7028 corresponding to the location of hand 7022 are the same as in FIG. 7G, because hand 7020 has not moved since initiating the first air pinch gesture, and hand 7022 has not moved since initiating the second air pinch gesture. In some embodiments, the user input by hand 7020 and the user input by hand 7022 are thus deemed to have failed to meet the concurrency criteria, because the user input by hand 7020 and the user input by hand 7022 were maintained for the second threshold amount of time Tₜₕ₂ without hand 7020 and hand 7022 moving relative to each other by at least the threshold amount of movement dₜₕ. Accordingly, in response to the second threshold amount of time Tₜₕ₂ expiring, computer system 101 delivers an input event (e.g., “Event 2”) for the user input by hand 7022 (e.g., after having initially delayed the sending of an input event corresponding to the second air pinch gesture by hand 7022, as described herein with reference to FIG. 7G), to the application associated with object 7012, the target of the user input by hand 7022. Like the input event “Event 2” in FIG. 7H, the input event “Event 2” in FIG. 7I optionally includes information identifying a location of the input, which in the example of FIG. 7I coincides with the location to which user 7002's gaze has remained directed (e.g., even if the location of the input is based on the location and/or movement of hand 7022, because hand 7022 has not moved since initiating the second air pinch gesture). Thus, in the scenario of FIG. 7I, at least one input event, “Event 1” of FIG. 7C, identifying user 7002's gaze location as the input location, has been delivered to the application associated with user interface 7010 for the user input by hand 7020, and at least one input event, “Event 2” of FIG. 7I, identifying user 7002's gaze location as the input location, has been delivered to the application associated with user interface 7010 for the user input by hand 7022 (e.g., the user input by hand 7020 and the user input by hand 7022 are processed as distinct inputs using distinct input manipulators due to failing to meet the concurrency criteria).

FIG. 7J illustrates another alternative transition from FIG. 7G in which, while hand 7020 is maintaining the first air pinch gesture and hand 7022 is maintaining the second air pinch gesture, hand 7020 moves relative to hand 7022 (e.g., hand 7020 is moved while hand 7022 is held still) by at least the threshold amount of movement dₜₕ downward and to the left. Because the threshold amount of movement dₜₕ of hand 7020 relative to hand 7022 is detected before timer 7016 elapses and thus within the threshold amount of time Tₜₕ₁, the user input by hand 7020 and the user input by hand 7022 meet the concurrency criteria (e.g., consistent with some embodiments in which the threshold amount of movement must be detected before timer 7016 has elapsed). In some embodiments, the concurrency criteria require that the threshold amount of movement dₜₕ of hand 7020 relative to hand 7022 be detected while hand 7020 is maintaining the first air pinch gesture and hand 7022 is maintaining the second air pinch gesture and before timer 7018 has elapsed, optionally without requiring that the threshold amount of movement dₜₕ be detected before timer 7016 has elapsed.

In accordance with the user input by hand 7020 and the user input by hand 7022 meeting the concurrency criteria, computer system 101 sends a set of associated input events. As shown in FIG. 7J, computer system 101 sends an input event “Event 2A” that cancels “Event 1” of FIG. 7C (e.g., “Event 2A” is a “input cancel” event (e.g., an input event that includes a “input cancel” phase value)). In addition, computer system 101 sends “Event 2B” with information describing the user input by hand 7020, and “Event 2C” with information describing the user input by hand 7022. Accordingly, the initial input event, “Event 1” of FIG. 7C, describing the first portion of the user input by hand 7020, is canceled so that the user input by hand 7020 is processed as part of a compound user input (e.g., together with the user input by hand 7022) performed using multiple input manipulators (e.g., in contrast to the user input by hand 7020 continuing to be processed as a single input manipulator user input as described herein with reference to FIGS. 7D, 7P, and 7R). Optionally, “Event 2A” is sent separately from “Event 2B” and “Event 2C,” or the information in “Event 2A” is included in “Event 2B” and/or “Event 2C” without a separate “Event 2A” being sent.

Because user 7002's gaze was directed to the same location when the user input by hand 7020 was first detected as when the user input by hand 7022 was first detected (or in some embodiments because user 7002's gaze was maintained at the same location between when the user input by hand 7020 was first detected and when the user input by hand 7022 was first detected), the user inputs by hand 7020 and hand 7022 have a common interaction point determined based on the location of user 7002's gaze, and thus object 7012 in user interface 7010 is the target of both input events “Event 2B” and “Event 2C.” Accordingly, input events “Event 2B” and “Event 2C” are both sent to the application associated with user interface 7010. However, because the user inputs by hand 7020 and hand 7022 have been recognized as being part of a compound, multiple input manipulator user input, information about the relative locations of hand 7020 and 7022 is needed in addition to the information about user 7002's gaze location. Accordingly, input event “Event 2B” for hand 7020 includes information identifying the location of the user input by hand 7020 as location 7026 in the three-dimensional environment that corresponds to a current location of hand 7020 (e.g., and does not necessarily coincide with user 7002's gaze location), and input event “Event 2C” for hand 7022 includes information identifying the location of the user input by hand 7022 as location 7028 in the three-dimensional environment that corresponds to a current location of hand 7022 (e.g., and does not necessarily coincide with user 7002's gaze location), where location 7026 and location 7028 are different.

FIG. 7K illustrates a transition from FIG. 7J and shows that, after the movement of hand 7020 by at least the threshold distance dₜₕ downward and to the left shown in FIG. 7J, the location of the user input by hand 7020 has changed to location 7030 in the three-dimensional environment, corresponding to the current location of hand 7020 after the movement by the distance dₜₕ, whereas the location of the user input by hand 7022, which has not moved, is still location 7028 in the three-dimensional environment. FIG. 7K illustrates that, in accordance with the user inputs by hand 7020 and hand 7022 meeting the concurrency criteria, and in response to the resulting input events “Event 2A,” “Event 2B,” and “Event 2C,” computer system 101 (e.g., more specifically, the application associated with user interface 7010, which includes target object 7012) performs a resizing operation with respect to object 7012 in accordance with the relative movement between hand 7020 and hand 7022 (e.g., based on the movement of hand 7020 away from hand 7022 while hand 7022 is held still, resulting in an increase in the distance between hand 7020 and hand 7022). Object 7012 in FIG. 7K is thus displayed at an increased scale relative to the prior scale of object 7012 as indicated by dotted outline 7046. In some embodiments, the amount by which object 7012 is resized is based on the amount of relative movement of hand 7020 and hand 7022 (e.g., where a greater change in distance between hand 7020 and hand 7022 causes a greater (or alternatively lesser) amount of resizing of object 7012, and a lesser change in distance between hand 7020 and hand 7022 causes a lesser (or alternatively greater) amount of resizing of object 7012) and/or based on the direction of relative movement between hand 7020 and hand 7022 (e.g., where movement of hand 7020 and hand 7022 closer together decreases (or alternatively increases) the scale or size of object 7012, and movement of hand 7020 and hand 7022 further apart increases (or alternatively decreases) the scale or size of object 7012).

In some embodiments, the resizing operation is performed relative to (e.g., centered on) a respective point in object 7012 corresponding to the common interaction point between the user input by hand 7020 and the user input by hand 7022 (e.g., the gaze location of user 7002, which was the same when the user input by hand 7020 was detected as when the user input by hand 7022 was detected).

In some embodiments, because the user inputs by hand 7020 and hand 7022 meet the concurrency criteria, the movement of input location 7026 in FIG. 7J to input location 7030 in FIG. 7K by an input movement magnitude d₀ shown in FIG. 7J optionally does not include input location acceleration relative to the movement of hand 7020 by the distance dₜₕ. In contrast, as described herein with reference to FIGS. 7D-7E, input movement magnitude d_{acc} in FIG. 7D includes input location acceleration relative to the movement of hand 7020 by the same distance dₜₕ, because the user input by hand 7020 in FIGS. 7D-7E is a single input manipulator input. Accordingly, the input movement magnitude do in FIG. 7J is less than the input movement magnitude d_{acc} in FIG. 7D. Relatedly, in some embodiments, the locations and movement of hand 7020 and hand 7022 are mapped to respective locations in the three-dimensional environment (e.g., location 7026 and location 7028) (e.g., optionally without input location acceleration) such that movement of hand 7020 and hand 7022 toward each other without crossing (e.g., without coming into contact) changes the mapped locations in the three-dimensional environment without the mapped locations crossing. For example, if hand 7020 were to move toward hand 7022 instead of away from hand 7022 as in FIG. 7J, location 7026 would change to move toward location 7028; however, if hand 7020 did not cross or pass hand 7022, location 7026 would not cross or pass location 7028.

FIG. 7L illustrates another alternative transition from FIG. 7G, and is analogous to FIG. 7J except that FIG. 7L indicates movement of hand 7020 downward and to the left by a distance dₐ (e.g., corresponding to movement of input location 7026 by an optionally unaccelerated input movement magnitude d₁) and movement of hand 7022 upward and to the right by a distance d_{b} (e.g., corresponding to movement of input location 7028 by an optionally unaccelerated input movement magnitude d₂), thus meeting the concurrency criteria because the total amount of movement of hand 7020 relative to hand 7022, dₐ+d_{b}, is at least the threshold amount of movement dₜₕ (e.g., in contrast to only hand 7020 moving by at least the threshold amount of movement dₜₕ while hand 7022 is held still in FIG. 7J). Input events “Event 2A,” “Event 2B,” and “Event 2C” in FIG. 7L are analogous to those in FIG. 7J (e.g., except that input events “Event 2B” and “Event 2C” indicate different input locations corresponding to the different locations and movement of hand 7020 and hand 7022, respectively, as compared with FIG. 7J).

FIG. 7M illustrates a transition from FIG. 7L that is analogous to the transition from FIG. 7J to FIG. 7K. FIG. 7M shows that, after the relative movement of hand 7020 and hand 7022 away from each other by at least the threshold distance dₜₕ (e.g., in response to input events “Event 2A,” “Event 2B,” and “Event 2C”), the resizing operation is performed with respect to target object 7012 (e.g., consistent with the changes in the input locations from locations 7026 for the user input by hand 7020 and location 7028 for the user input by hand 7022 in FIG. 7L to location 7032 and location 7034, respectively, in FIG. 7M, and thus consistent with the total input movement magnitude d₁+d₂). Object 7012 in FIG. 7M is thus displayed at an increased scale relative to the prior scale of object 7012 as indicated by dotted outline 7046.

In some embodiments, as shown in the example of FIG. 7M, because the user inputs by hand 7020 and hand 7022 in FIG. 7L have the same common interaction point (e.g., based on the gaze location of user 7002 being the same when the user input by hand 7020 was detected as when the user input by hand 7022 was detected) as in FIG. 7J, the resizing operation is performed relative to (e.g., centered on) the same point in object 7012 in FIG. 7M as in FIG. 7K, and thus the user interface response in FIG. 7M is the same as in FIG. 7K even though the movement of hands 7020 and 7022 is different in FIG. 7L than in FIG. 7J (e.g., even though the positioning of hands 7020 and 7022 in FIG. 7K after the movement by hand 7020 alone is different from the positioning of hands 7020 and 7022 in FIG. 7M after the movement in opposite directions by hand 7020 and hand 7022). Thus, in FIG. 7M, resized object 7012 has the same spatial relationship to dotted outline 7046 (e.g., representing the size and position of object 7012 before the resizing operation) as resized object 7012 in FIG. 7K has to dotted outline 7046.

FIG. 7N illustrates another alternative transition from FIG. 7G, and is similar to FIG. 7L except that FIG. 7N indicates hand 7020 and hand 7022 revolving around each other to perform a rotation gesture (e.g., in contrast to moving toward or away from each other to perform a resizing operation as in FIG. 7L). In FIG. 7N, hand 7020 moves downward (e.g., optionally along a curved path) past hand 7022 by a distance dₐ, and hand 7022 moves upward (e.g., optionally along a curved path) past hand 7020 by a distance de, thus meeting the concurrency criteria because the total amount of movement of hand 7020 relative to hand 7022 dₐ+d_{b} is at least the threshold amount of movement dₜₕ (optionally, a hand revolving around the other hand by at least the threshold amount of movement dₜₕ while the other hand is held still would also meet the concurrency criteria). Input events “Event 2A,” “Event 2B,” and “Event 2C” in FIG. 7N are analogous to those in FIG. 7L (e.g., except that input events “Event 2B” and “Event 2C” indicate different input locations corresponding to the different locations and movement of hand 7020 and hand 7022, respectively, as compared with FIG. 7L).

FIG. 7O illustrates a transition from FIG. 7N that is similar to the transition from FIG. 7L to FIG. 7M except that FIG. 7O shows that, after the relative movement of hand 7020 and hand 7022 around each other by at least the threshold distance dₜₕ, a rotation operation is performed with respect to object 7012 in accordance with the revolution of hand 7020 and hand 7022 relative to each other (e.g., consistent with the changes in the input locations from locations 7026 for the user input by hand 7020 and location 7028 for the user input by hand 7022 in FIG. 7N to location 7036 and location 7038, respectively, in FIG. 7O) (e.g., where a greater amount of revolution of hand 7020 and hand 7022 causes a greater (or alternatively lesser) amount of rotation of object 7012, and a lesser amount of revolution of hand 7020 and hand 7022 causes a lesser (or alternatively greater) amount of rotation of object 7012; and/or where clockwise revolution of hand 7020 and hand 7022 rotates object 7012 clockwise (or alternatively counterclockwise), and counterclockwise revolution of hand 7020 and hand 7022 rotates object 7012 counterclockwise (or alternatively clockwise)). Object 7012 in FIG. 7O is thus displayed rotated relative to the prior orientation of object 7012 as indicated by dotted outline 7046.

FIGS. 7P-7Q illustrate another alternative transition from FIG. 7C, involving performing distinct operations with respect to distinct target objects in response to user inputs that are performed using different input manipulators and do not meet the concurrency criteria. In FIG. 7P, hand 7020 has completed the first air pinch gesture (e.g., by breaking contact between the fingers that were in contact in FIG. 7C), thus ending the user input by hand 7020. In some embodiments, computer system 101 delivers an input event “Event 1-2” to the application associated with user interface 7010 (e.g., because object 7012 in user interface 7010 is the target of the user input by hand 7020) to indicate the end of the user input by hand 7020. In some embodiments, input event “Event 1-2” follows input event “Event 1” of FIG. 7C and provides updated information about the user input by hand 7020, including the fact that the user input by hand 7020 has ended (e.g., input event “Event 1-2” is a “input end” event (e.g., an input event that includes a “input end” phase value)). The input event “Event 1-2” optionally includes information identifying a location of the input, determined based on the current location of hand 7020 and/or an amount of movement of hand 7020 since detection of the first air pinch gesture; however, because hand 7020 has not moved since the first air pinch gesture was detected while user 7002's gaze was directed to object 7012, the location of the user input included in input event “Event 1-2” would be the same as in input event “Event 1” of FIG. 7C. In response to the input event “Event 1-2” indicating the end of the user input by hand 7020 directed to target object 7012, computer system 101 (e.g., more specifically, the application associated with user interface 7010) performs a selection operation with respect to object 7012 (e.g., as described herein with reference to FIG. 7H). Accordingly, the user input by hand 7020 is processed as a single input manipulator user input without regard to the user input by hand 7022.

In addition, in FIG. 7P, user 7002 has shifted their gaze from object 7012 to object 7024, and a second air pinch gesture performed by hand 7022 is detected while user 7002's gaze is directed to location 7040 within object 7024. The user input by hand 7022 that includes the second air pinch gesture does not meet concurrency criteria with the user input by hand 7020, because the user input by hand 7022 is directed to a different target, in accordance with user 7002's gaze moving from object 7012 to object 7024, than was the user input by hand 7020. Accordingly, computer system 101 delivers an input event (e.g., “Event 2-1”), optionally including location 7040 as the input location, to an application associated with target object 7024, which in the example of FIG. 7P is the same application, associated with user interface 7010, to which input event “Event 1-2” is delivered. One of ordinary skill in the art will recognize that if object 7024 were instead part of a different user interface associated with a second application different from the application associated with user interface 7010, input event “Event 2” would be delivered to the second application instead of to the application associated with user interface 7010. Optionally, as shown in FIG. 7P, object 7024 is visually emphasized in appearance (e.g., highlighted and/or other visual emphasis associated with object targeting) to indicate that object 7024 is a current input target (e.g., of the user input by hand 7022).

FIG. 7Q illustrates an example transition from FIG. 7P in which hand 7022 completes the second air pinch gesture (e.g., by breaking contact between the fingers that were in contact), thus ending the user input by hand 7022. In response to detecting the end of the second air pinch gesture by hand 7022, computer system 101 delivers an input event (e.g., “Event 2-2”) for the end of the user input by hand 7022; input event “Event 2-2” is delivered to the application associated with target object 7024, or more generally to the application associated with user interface 7010, which includes target object 7024. Accordingly, computer system 101 (e.g., more specifically, the application associated with user interface 7010) performs a selection operation with respect to object 7024 (e.g., as described herein with reference to FIG. 7H) and optionally performs a deselection operation with respect to object 7012 (e.g., by removing at least some, or all, of the visual emphasis associated with object selection that was applied in response to input event “Event 1-2” of FIG. 7P). Accordingly, the user input by hand 7022 is processed as a single input manipulator user input without regard to the earlier user input by hand 7020.

FIGS. 7R-7S illustrates another alternative transition from FIG. 7C, involving performing distinct yet concurrent operations with respect to distinct target objects in response to user inputs that are performed using different input manipulators and do not meet the concurrency criteria. In FIG. 7R, hand 7020 has maintained the first air pinch gesture for at least a threshold amount of time Tₜₕ₁ (e.g., since the scenario of FIG. 7C), and hand 7022 has initiated a second air pinch gesture while user 7002's gaze is directed to object 7024 (optionally after at least the threshold amount of time Tₜₕ₁ elapsed). Hand 7020 moves downward and to the left by a distance d_{L} while maintaining the first air pinch gesture, while hand 7022 moves downward and to the right by a distance d_{R} while maintaining the second air pinch gesture.

FIG. 7R shows that computer system 101 delivers an input event (e.g., “Event 1B” in FIG. 7R, which is similar to input event “Event 1B” in FIG. 7D) with information about the portion of the user input by hand 7020 that includes the movement shown in FIG. 7R. For example, input event “Event 1B” in FIG. 7R indicates a change in input location 7026 to input location 7042 (FIG. 7S) that is based on the location and movement of hand 7020 as illustrated in FIG. 7R. In some embodiments, the amount of movement d_{L} of hand 7020 corresponds to a magnitude of movement d_{L,acc} of the input location, and the input movement magnitude is optionally accelerated (e.g., scaled linearly (e.g., using a multiplier) or non-linearly (e.g., using a non-linear function that is based on an amount or speed of input manipulator movement)) relative to the amount of movement of hand 7020 (e.g., d_{L,acc}>d_{L}).

Similarly, computer system 101 delivers an input event (e.g., “Event 2” in FIG. 7R, which is analogous to input event “Event 2-1” in FIG. 7P) with information about an initial portion of the user input by hand 7022 (e.g., the initiation of the second air pinch gesture) (e.g., in response to which object 7024 is optionally visually emphasized in appearance, such as with highlighting and/or other visual emphasis associated with object targeting, to indicate that object 7024 is a current input target). In addition, computer system 101 delivers an input event (e.g., “Event 2D” in FIG. 7R) with information about a subsequent portion of the user input by hand 7022 that includes the movement shown in FIG. 7R. For example, input event “Event 2D” in FIG. 7R indicates a change in input location 7040 to input location 7044 (FIG. 7S) that is based on the location and movement of hand 7022 as illustrated in FIG. 7R. In some embodiments, the amount of movement d_{R} of hand 7022 corresponds to a magnitude of movement d_{R,acc} of the input location, and the input movement magnitude is optionally accelerated (e.g., scaled linearly (e.g., using a multiplier) or non-linearly (e.g., using a non-linear function that is based on an amount or speed of input manipulator movement)) relative to the amount of movement of hand 7022 (e.g., d_{R,acc}>d_{R}).

FIG. 7S illustrates an example transition from FIG. 7R in which computer system 101 (e.g., more specifically, the application associated with user interface 7010) performs a move operation with respect to object 7012 based on input event “Event 1B,” concurrently with performing a move operation with respect to object 7024 based on input event “Event 2D.” In FIG. 7S, in response to the input event “Event 1B” indicating the movement of hand 7020 by the distance d_{L} to the location of hand 7020 shown in FIG. 7E, object 7012 is moved in user interface 7010 (e.g., away from the prior position of object 7012 as shown in FIG. 7R and as indicated by dotted outline 7046 in user interface 7010 in FIG. 7S) by a corresponding (and optionally accelerated) amount d_{L,acc} of movement of the input location. In response to the input event “Event 2D” indicating the movement of hand 7022 by the distance d_{R} to the location of hand 7022 shown in FIG. 7S, object 7024 is moved in user interface 7010 (e.g., away from the prior position of object 7012 as shown in FIG. 7R and as indicated by dotted outline 7048 in user interface 7010 in FIG. 7S) by a corresponding (and optionally accelerated) amount d_{R,acc} of movement of the input location.

In FIG. 7S, the operation performed with respect to object 7012 is independent of the operation performed with respect to object 7024, because the user input by hand 7020 and the user input by hand 7022 do not meet the concurrency criteria. As such, and because, in some embodiments, the amount of movement d_{L,acc} of object 7012 is accelerated relative to the amount of movement amount d_{L} of hand 7020 while the amount of movement d_{R,acc} of object 7024 is accelerated relative to the amount of movement amount d_{R} of hand 7022, it is possible for object 7012 and object 7024 to cross or pass each other even if hand 7020 and hand 7022 do not cross or pass each other (e.g., if hand 7020 and hand 7022 were to move toward each other instead of in the directions shown in FIGS. 7R-7S) (e.g., because the input locations for the user inputs by hand 7020 and hand 7022 are not mapped as described herein with reference to FIGS. 7J-7K).

Although FIG. 7S shows object 7012 and object 7024 within the same user interface 7010 of the same application, and input events for both the user input by hand 7020 (e.g., “Event 1B”) and the user input by hand 7022 (e.g., “Event 2” and “Event 2D”) delivered to the same application, in some embodiments if object 7012 and object 7024 were in different user interfaces associated with different applications, computer system 101 would similarly deliver the different input events to the different applications (e.g., “Event 1B” to a first application and “Event 2” and “Event 2D” to a second application that is different from the first application) and perform a move operation with respect to object 7012 (e.g., in a user interface of the first application) concurrently with performing a move operation with respect to object 7024 (e.g., in a user interface of the second application, different from the user interface of the first application). Accordingly, the user input by hand 7020 is processed as a single input manipulator user input without regard to the user input by hand 7022, and the user input by hand 7022 is processed as a single input manipulator user input without regard to the user input by hand 7020.

Additional descriptions regarding FIGS. 7A-7G are provided below in reference to method 800 described with respect to FIGS. 8A-8D.

FIGS. 8A-8D are flow diagrams of an exemplary method 800 for processing inputs performed using different numbers of input manipulators, in accordance with some embodiments. In some embodiments, method 800 is performed at a computer system (e.g., computer system 101 in FIG. 1A) that is in communication with a display generation component (e.g., display generation component 120 in FIGS. 1A, 3, and 4) (e.g., a heads-up display, a head-mounted device, a display, a touchscreen, a projector, or the like) and one or more input devices (e.g., one or more cameras (e.g., color sensors, infrared sensors, structured light scanners, and/or other depth-sensing cameras) that point downward at a user's hand, forward from the user's head, and/or that faces the user; eye-tracking devices; user-held and/or user-worn controllers; and/or other input hardware). In some embodiments, the method 800 is governed by instructions that are stored in a non-transitory (or transitory) computer-readable storage medium and that are executed by one or more processors of a computer system, such as the one or more processors 202 of computer system 101 (e.g., control 110 in FIG. 1A). Some operations in method 800 are, optionally, combined and/or the order of some operations is, optionally, changed.

While a view of an environment is visible via the display generation component (e.g., the environment being a two-dimensional or three-dimensional environment that includes one or more computer-generated portions and optionally one or more passthrough portions), the computer system displays (802) a user interface including one or more user interface objects (e.g., user interface 7010 including object 7012 and object 7024 (FIG. 7B)). The computer system detects (804), via the one or more input devices, one or more inputs (e.g., user inputs by hand 7020 and/or hand 7022, as described herein with reference to FIGS. 7B-7S).

In accordance with a determination that the one or more inputs include a first input performed using a first input manipulator (e.g., in a physical environment, such as a first hand of a user, contact on a touch-sensitive surface, controller, wand, mouse, or other input manipulator) and a second input performed using a second input manipulator (e.g., in the physical environment, such as a second hand of a user, contact on a touch-sensitive surface, controller, wand, mouse, or other input manipulator) distinct from the first input manipulator, where the first input and the second input meet concurrency criteria (and in some embodiments in response to detecting the one or more inputs) (806), the computer system: provides (808) a first input event for the first input to a first application, and provides (810) a second input event for the second input to the first application. The first input event includes information identifying a target location. The second input event includes information identifying the target location (e.g., the same target location that is identified by the first input event). For example, as described herein with reference to FIGS. 7J-7K, 7L-7M, and 7N-7O, the user input by hand 7020 and the user input by hand 7022 meet concurrency criteria, and computer system provides input events “Event 2B” with information about the user input by hand 7020 and “Event 2C” with information about the user input by hand 7022 to the application associated with user interface 7010.

In some embodiments, the first input corresponds to a first location in the user interface and the first input event also includes information identifying the first location (e.g., location 7026 (FIGS. 7J, 7L, and 7N)). In some embodiments, the second input corresponds to a second location in the user interface and the second input event also includes information identifying the second location (e.g., location 7028 (FIGS. 7J, 7L, and 7N)). In some embodiments, the first application includes instructions for rendering or displaying at least a portion of the user interface (e.g., the computer system uses the first application to render or display at least a portion of the user interface, such as a respective user interface object, that corresponds to the target location and/or both the first location and the second location). In some embodiments, the first input event and/or the second input event are provided to the first application upon determination that the detected first and second inputs meet the concurrency criteria (e.g., automatically, without requiring an intervening user request for information such as the first location corresponding to the first input manipulator and/or the second location corresponding to the second input manipulator, such as in FIGS. 7J, 7L, and 7N described herein).

In some embodiments, a method includes: while a view of an environment is visible via the display generation component, displaying a user interface including one or more user interface objects; detecting, via the one or more input devices, one or more inputs; and, in accordance with a determination that the one or more inputs include a first input performed using a first input manipulator and a second input performed using a second input manipulator distinct from the first input manipulator, and that the first input and the second input meet concurrency criteria: performing a first operation based on the first input, the second input, and a target location.

Where multiple inputs are performed using different input manipulators and meet concurrency criteria, such as inputs performed using a user's two hands at the same time or close in time and/or otherwise meeting criteria for a two-handed gesture more generally, providing to a corresponding application distinct input events that identify a same target location yet are associated with different input locations for the different input manipulators enables the receiving application to distinguish between concurrent inputs from different input manipulators and also to understand relative locations and relative movement of the input manipulators and use this information in performing a user interface operation in response, rather than only knowing location and movement of the input manipulators independently of each other. This increases flexibility in input processing and the range of inputs supported, thereby making interaction with the computer system more efficient (e.g., by reducing the number of inputs needed to perform operations and/or enabling operations to be performed without displaying additional controls).

In some embodiments, in accordance with a determination that the one or more inputs include a respective input performed using a single input manipulator without receiving another input that meets the concurrency criteria (e.g., without receiving any other input that is concurrent with the respective input, such as receiving the first input without the second input or any other concurrent input performed using the second input manipulator, receiving an input provided using one hand and not both hands) (812), the computer system performs a respective operation corresponding to the respective input performed using the single input manipulator (e.g., without also performing another operation corresponding to another input manipulator). For example, as described herein with reference to FIGS. 7D-7E, object 7012 is moved in user interface 7010 because the user input by hand 7020 is performed using a single input manipulator without receiving another user input (e.g., by hand 7022) that meets the concurrency criteria with the user input by hand 7020. Where an input is performed using a single input manipulator, such as one hand, performing a corresponding operation based on information about the single input manipulator (e.g., without needing to consider information about multiple input manipulators) simplifies input processing and reduces the amount of time needed to perform operations on the computer system.

In some embodiments, in accordance with a determination that the one or more inputs include the first input performed using the first input manipulator and the second input performed using the second input manipulator and that the first input and the second input do not meet the concurrency criteria (814), the computer system: performs a first operation corresponding to the first input performed using the first input manipulator; and performs a second operation corresponding to the second input performed using the second input manipulator. The second operation is distinct from the first operation. In some embodiments, the first operation is performed independently from the second input. In some embodiments, the second operation is performed independently from the first input. In some circumstances, the first operation and the second operation are performed concurrently (e.g., when the first input and the second input are performed concurrently and/or overlap each other in time), whereas in some circumstances the first operation and the second operation are not performed concurrently (e.g., when the first input and the second input are performed at different times and/or do not overlap in time). For example, as described herein with reference to FIGS. 7P-7Q, the user inputs by hand 7020 and hand 7022 do not meet the concurrency criteria, so successive selection operations are performed with respect to first object 7012 (e.g., targeted by the user input by hand 7020) and then object 7024 (e.g., targeted by the user input by hand 7022). In another example, as described herein with reference to FIGS. 7R-7S, the user inputs by hand 7020 and hand 7022 do not meet the concurrency criteria, so concurrent move operations are performed with respect to object 7012 (e.g., targeted by the user input by hand 7020) and object 7024 (e.g., targeted by the user input by hand 7022). Where multiple inputs are performed using different input manipulators and do not meet concurrency criteria, such as inputs performed using two hands but at different times or performed at the same time or close in time but not meeting other criteria for a two-handed gesture, performing distinct operations corresponding respectively to the different input manipulators (e.g., without needing to coordinate information about multiple input manipulators) simplifies input processing and reduces the amount of time needed to perform operations on the computer system.

In some embodiments, in accordance with the determination that the one or more inputs include the first input and the second input where the first input and the second input meet the concurrency criteria, the computer system performs (816) an operation in accordance with relative movement between the first input manipulator and the second input manipulator (e.g., movement of the first input manipulator relative to a stationary second input manipulator, movement of the second input manipulator relative to a stationary first input manipulator, or movement of both the first input manipulator and the second input manipulator, that changes a distance or spacing between the first input manipulator and the second input manipulator). For example, as described herein with reference to the compound, multiple input manipulator user inputs in FIGS. 7J-7K, 7L-7M, and 7N-7O, different operations are performed on object 7012 in accordance with relative movement between hand 7020 and hand 7022. Where multiple inputs are performed using different input manipulators, such as two hands of a user, and meet concurrency criteria, performing a two-handed operation that is controlled at least in part by relative movement between the two input manipulators increases the range of inputs supported and accordingly the range of operations that can be performed, thereby making interaction with the computer system more efficient (e.g., by reducing the number of inputs needed to perform operations and/or enabling operations to be performed without displaying additional controls).

In some embodiments, performing the operation includes (818): in accordance with a determination that a first magnitude of relative movement occurs between the first input manipulator and the second input manipulator, performing the operation with a first operation magnitude; and, in accordance with a determination that a second magnitude of relative movement occurs between the first input manipulator and the second input manipulator, where the second magnitude of relative movement is different from the first magnitude of relative movement, performing the operation with a second operation magnitude that is different from the first operation magnitude (e.g., as described herein with reference to the compound, multiple input manipulator user inputs in FIGS. 7J-7K, 7L-7M, and 7N-7O). Where multiple inputs are performed using different input manipulators, such as two hands of a user, and meet concurrency criteria, performing a two-handed operation with an operation magnitude that is based on the amount of relative movement between the different input manipulators enables manipulation of objects in a user interface faster and with better and more intuitive control.

In some embodiments, the target location corresponds (820) to a respective user interface object of the one or more user interface objects (e.g., object 7012 in user interface 7010 is the target of the compound, multiple input manipulator user inputs in FIGS. 7J-7K, 7L-7M, and 7N-7O). Enabling an operation to be performed on a particular user interface object at a target location that is a shared point of interaction between multiple input manipulators reduces the amount of time needed to perform operations on the computer system and enables an increased range of operations to be performed without displaying additional controls.

In some embodiments, performing the operation includes (822) rotating the respective user interface object (e.g., by a first amount of rotation in accordance with the first magnitude of relative movement between the first and second input manipulators, and by a second amount of rotation in accordance with the second magnitude of relative movement between the first and second input manipulators). For example, counterclockwise movement of the first input manipulator relative to the second input manipulator (and/or of the second input manipulator relative to the first input manipulator) about a respective axis in the physical environment rotates the respective user interface object counterclockwise (or in some embodiments clockwise) about a corresponding axis in the visible environment, whereas clockwise movement of the first input manipulator relative to the second input manipulator (and/or of the second input manipulator relative to the first input manipulator) about the respective axis in the physical environment rotates the respective user interface object clockwise (or in some embodiments counterclockwise) about the corresponding axis in the physical environment. For example, as described herein with reference FIGS. 7N-7O, a rotation operation is performed on object 7012 (e.g., in accordance with magnitude and/or direction of relative movement between hand 7020 and hand 7022). Enabling a particular user interface object to be rotated in response to inputs performed using multiple input manipulators meeting concurrency criteria reduces the amount of time needed to perform such operations on the computer system and enables an increased range of operations to be performed without displaying additional controls.

In some embodiments, performing the operation includes (824) changing a zoom scale of the respective user interface object (e.g., by a first amount of change in zoom scale in accordance with the first magnitude of relative movement between the first and second input manipulators, and by a different, second amount of change in zoom scale in accordance with the second magnitude of relative movement between the first and second input manipulators). For example, moving the first input manipulator and the second input manipulator closer together zooms the respective user interface object out (e.g., reduces a scale of the respective user interface object) (or in some embodiments zooms in (e.g., increases the scale of the respective user interface object)), whereas moving the first input manipulator and the second input manipulator further apart zooms the respective user interface object in (or in some embodiments zooms out). For example, as described herein with reference FIGS. 7J-7K and 7L-7M, a resizing (e.g., or rescaling or zoom) operation is performed on object 7012 (e.g., in accordance with magnitude and/or direction of relative movement between hand 7020 and hand 7022). Enabling a particular user interface object to be resized, rescaled, or zoomed in or out in response to inputs performed using multiple input manipulators meeting concurrency criteria reduces the amount of time needed to perform such operations on the computer system and enables an increased range of operations to be performed without displaying additional controls.

In some embodiments, performing the operation includes (826) panning the respective user interface object (e.g., panning by a first amount in accordance with the first magnitude of relative movement between the first and second input manipulators, and by a second amount in accordance with the second magnitude of relative movement between the first and second input manipulators). For example, if hand 7020 and hand 7022 moved in the same direction as each other in FIG. 7L (e.g., instead of away from or toward each other to perform a zoom or resizing operation), a panning operation would optionally be performed in user interface 7010 (e.g., such as by shifting object 7012 and object 7024 and other elements displayed in user interface 7010 while maintaining relative spatial relationships between the various elements displayed in user interface 7010). Enabling a particular user interface object to be panned in response to inputs performed using multiple input manipulators meeting concurrency criteria reduces the amount of time needed to perform such operations on the computer system and enables an increased range of operations to be performed without displaying additional controls.

In some embodiments, detecting the one or more inputs includes (828) detecting one or more air gestures (e.g., air pinch, air pinch and drag, or other air gesture). For example, the user inputs by hand 7020 and hand 7022 described herein with reference to FIGS. 7C-7S include various air gestures such as air pinch gestures and air pinch-and-drag gestures (e.g., movement of a hand while maintaining an air pinch gesture). In some embodiments, detecting the one or more inputs includes detecting multiple (e.g., two or more) air gestures, such as two (or more) air pinch gestures (e.g., as described herein with reference to FIG. 7F), an air pinch gesture and an air pinch-and-drag gesture (e.g., as described herein with reference to FIG. 7J), two (or more) air pinch-and-drag gestures (e.g., as described herein with reference to FIGS. 7L, 7N, and 7R), or other combination of air gestures. Performing an operation responsive to one or more air gestures, and in particular performing an operation responsive to multiple air gestures performed using different input manipulators, such as two hands of a user, meeting concurrency criteria increases the range of inputs supported and thus enables operations to be performed more quickly and intuitively on the computer system.

In some embodiments, determining that the first input and the second input meet the concurrency criteria includes (830) determining that the second input is detected within a first threshold amount of time since detecting the first input (e.g., within the threshold amount of time Tₜₕ₁ as described herein with reference to FIG. 7G in contrast to FIG. 7F). In some embodiments, the concurrency criteria require that the first input and the second input are directed to the same target location (e.g., the target location corresponding to the respective user interface object). In some embodiments, if the concurrency criteria are not met based on the first input being directed to a different target location than the second input is directed to, an input event for the first input is sent to a different target location than an input event for the second input (e.g., and different corresponding operations associated with the different target locations are performed in response). Requiring that multiple inputs performed using different input manipulators be detected within a threshold amount of time of each other in order to meet concurrency criteria for performing a multi-handed (e.g., two-handed) operation disambiguates from (e.g., discrete) inputs intended to perform distinct operations for different input manipulators, which increases the range of inputs supported and accordingly the range of operations that can be performed, thereby reducing the amount of time needed to perform operations on the computer system.

In some embodiments, determining that the first input and the second input meet the concurrency criteria also includes (832) determining that a threshold amount of relative movement between the first input manipulator and the second input manipulator is detected within a second threshold amount of time (e.g., since detecting the first input, or the earlier of the first input and the second input (e.g., within the threshold amount of time Tₜₕ₁ as described herein with reference to FIG. 7J in contrast to FIG. 7H), or since detecting the second input, or the later of the first input and the second input (e.g., within the threshold amount of time Tₜₕ₂ as described herein with reference to FIG. 7I)). In some embodiments, the second threshold amount of time (e.g., Tₜₕ₂) is (e.g., runs concurrently with) the first threshold amount of time (e.g., Tₜₕ₁). In some embodiments, the second threshold amount of time is distinct from (e.g., starts after and/or is less than or greater than) the first threshold amount of time. Requiring that multiple inputs performed using different input manipulators move relative to each other by a threshold movement amount within a threshold amount of time in order to meet concurrency criteria for performing a multi-handed (e.g., two-handed) operation disambiguates from (e.g., stationary) inputs intended to perform distinct operations for different input manipulators, which increases the range of inputs supported and accordingly the range of operations that can be performed, thereby reducing the amount of time needed to perform operations on the computer system.

In some embodiments, the first input corresponds (834) to a first location in the user interface (e.g., corresponding to the first input manipulator, and included in the first input event) different from the target location (e.g., location 7026 for the user input by hand 7020 in FIG. 7G is different from the target location determined based on user 7002's gaze location in FIG. 7C), and the second input corresponds to a second location in the user interface (e.g., corresponding to the second input manipulator, and included in the second input event) different from the target location (e.g., location 7028 for the user input by hand 7022 in FIG. 7G is different from the target location determined based on user 7002's gaze location in FIG. 7G). In some embodiments, the input events are sent to the respective user interface object (e.g., object 7012 in FIGS. 7J, 7L, and 7N) because the initial target location was in the respective user interface object (e.g., within object 7012 based on user 7002's gaze location in FIGS. 7C and 7G), even if at least one of the first location or the second location is outside of the respective user interface object. Providing, for different inputs performed using different input manipulators and meeting concurrency criteria, distinct input events that are associated with distinct, spaced apart input locations as well as with a common target location enables the receiving application to distinguish between concurrent inputs from different input manipulators and to also understand relative locations and relative movement of the input manipulators and use this information in performing a user interface operation in response, which increases flexibility in input processing and the range of inputs supported, and accordingly the range of operations that can be performed, thereby reducing the amount of time needed to perform operations on the computer system.

In some embodiments, the target location corresponds (836) to a location in the environment to which a user's attention (e.g., based on gaze) is directed. For example, a location in object 7012 is the target location (e.g., and common interaction point for hands 7020 and 7022) for the resizing operations performed in FIGS. 7J-7K and 7L-7M based on user 7002 gazing at the location in object 7012 in FIGS. 7C and 7G. Selecting the target location for inputs, including for different inputs performed using different input manipulators and meeting concurrency criteria, based on a location at which a user is gazing and/or to which the user's attention is directed more generally (e.g., when a respective input is detected) makes target selection for corresponding operations to be performed more intuitive and precise, which reduces user mistakes and the amount of time needed to perform operations on the computer system.

In some embodiments, detecting the one or more inputs includes (838) detecting the first input performed using the first input manipulator prior to detecting the second input performed using the second input manipulator. In some embodiments, in response to detecting the first input performed using the first input manipulator, prior to detecting the second input performed using the second input manipulator: the computer system provides, to the first application, a third input event corresponding to the first input manipulator (e.g., input event “Event 1” as described herein with reference to FIG. 7C). Where an input is performed using an input manipulator such as one hand (e.g., prior to detecting a second input performed using a second input manipulator such as the other hand), providing an input event that represents and includes information about the input enables the receiving application to begin processing and responding to the input more quickly and thereby provide prompt feedback about the state of the computer system.

In some embodiments, detecting the one or more inputs includes (840) detecting the second input performed using the second input manipulator (e.g., after detecting the first input performed using the first input manipulator). In some embodiments, in response to detecting the second input performed using the second input manipulator: the computer system provides, to the first application, a fourth input event that includes an instruction to the first application to cancel or ignore the third input event (e.g., the fourth input event cancels the input of the third input event) (e.g., input event “Event 2A” as described herein with reference to FIGS. 7J, 7L, and 7N). In some embodiments, the fourth input event is sent to the first application in conjunction with sending the first input event and the second input event corresponding to the two different input manipulator locations. In some embodiments, the instruction to the first application to ignore the third input event is included in the first input event and/or the second input event (instead of separately in a fourth input event). In some embodiments, the instruction to the first application to ignore the third input event is provided in response to determining that the first input and the second input meet the concurrency criteria (e.g., detected within a threshold amount of each other and/or including a threshold amount of movement relative to each other). After an earlier input event is provided for a first input performed using a first input manipulator, canceling the earlier input event in response to detecting a second input performed using a second input manipulator (and optionally in conjunction with providing input events for the first input and the second input meeting concurrency criteria) enables the receiving application to process inputs more accurately to determine an appropriate user interface response, which provides improved feedback about the state of the computer system.

In some embodiments, in response to detecting (e.g., a start of or at least a portion of) the second input performed using the second input manipulator, the computer system delays (842) providing an input event for the second input to the first application (e.g., until determining whether the concurrency criteria are met or until detecting an end of the second input without the concurrency criteria being met). For example, as described herein with reference to FIG. 7G, the sending of an input event for at least an initial portion of the user input by hand 7022 is delayed. In some embodiments, delaying providing an input event for the second input to the first application includes forgoing providing an input event for the second input to the first application for a respective amount of time (e.g., until determining whether the concurrency criteria are met or until detecting an end of the second input without the concurrency criteria being met). After an earlier input event is provided for a first input performed using a first input manipulator, delaying providing, to a corresponding application, an input event for a detected second input performed using a second input manipulator allows the computer system time to interpret the second input (e.g., to determine whether the second input was accidental, whether the second input together with the first input meet the concurrency criteria, and accordingly how to represent the second input (and relatedly the first input) accurately in input events), which reduces user mistakes and makes interaction with the computer system more efficient by reducing the chance of the receiving application producing an unintended user interface response.

In some embodiments, after delaying providing an input event for the second input to the first application, the computer system detects (844) an end of the second input performed using the second input manipulator; and, in response to detecting the end of the second input, in accordance with a determination that the concurrency criteria are not met, the computer system provides, to the first application, an input event for the second input. For example, as described herein with reference to FIG. 7H, input event “Event 2” is delivered to the application associated with user interface 7010 in response to detecting the end of the user input (e.g., a depinch that concludes the second air pinch gesture) by hand 7022. In some embodiments, the input event for the second input represents the occurrence of the second input and is based on the target location in the respective user interface object (e.g., rather than on a location corresponding to the second input manipulator, because the concurrency criteria were not met). After delaying providing an input event for a second input performed using a second input manipulator, providing, to a corresponding application, an input event for the second input in response to detecting an end of the second input where the concurrency criteria are not met enables the receiving application to begin processing and responding to the second input more quickly and thereby provide prompt feedback about the state of the computer system.

In some embodiments, after delaying providing an input event for the second input to the first application, in accordance with a determination that the concurrency criteria are not met, the computer system provides (846), to the first application, an input event for the second input. In some embodiments, the input event for the second input, representing the occurrence of the second input, is provided to the first application even if an end of the second input is not detected (e.g., if the concurrency criteria fail to be met even while the second input continues to be detected, such as due to the first input ceasing to be detected, or due to insufficient movement by the first input and/or by the second input being detected within a threshold amount of time). For example, as described herein with reference to FIG. 7I, input event “Event 2” is delivered to the application associated with user interface 7010 after the second threshold amount of time Tₜₕ₂ has elapsed (e.g., even though the user input by hand 7022 is ongoing). After delaying providing an input event for a second input performed using a second input manipulator, providing, to a corresponding application, an input event for the second input once it has been determined that the concurrency criteria are not met enables the receiving application to begin processing and responding to the second input more quickly and thereby provide prompt feedback about the state of the computer system.

In some embodiments, the first application is configured to, in response to receiving the input event for the second input, perform (848) a selection operation with respect to a respective user interface object (e.g., of the one or more user interface objects; the respective user interface object corresponding to and/or including the target location). For example, as described herein with reference to FIG. 7H, a selection operation is performed with respect to object 7012 in response to input event “Event 2” delivered to the application associated with user interface 7010. Enabling a receiving application to perform a selection operation with respect to a target object in response to an input event for the second input, which does not meet the concurrency criteria, produces an intuitive user interface response while reducing the amount of time needed to perform operations on the computer system.

In some embodiments, in accordance with the determination that the one or more inputs include the first input performed using the first input manipulator and the second input performed using the second input manipulator, where the first input and the second input meet the concurrency criteria: a location of the first input manipulator is (850) mapped to a location of the first input, and a location of the second input manipulator is mapped to a location of the second input, such that relative movement between the first input manipulator and the second input manipulator without the first input manipulator and the second input manipulator crossing (e.g., along one or more axes in a physical environment) moves the first input and the second input relative to each other without the location of the first input and the location of the second input crossing each other (e.g., along one or more corresponding axes in the environment visible via the computer system). Mapping of input manipulator locations to input locations send as part of input events in a manner that avoids the input locations crossing if the input manipulators have not crossed, at least for a compound user input performed using multiple input manipulators is described herein with reference to FIGS. 7J-7K (e.g., in contrast to possible crossing of input locations for independent user inputs as described herein with reference to FIGS. 7R-7S). In some embodiments, in response to detecting the first and second inputs that meet the concurrency criteria, the computer system performs an operation with respect to the respective user interface object (e.g., rotating, zooming, panning, or other operation) in accordance with relative movement between the first input manipulator and the second input manipulator. In some embodiments, as the first input manipulator and the second manipulator are brought closer together without coinciding, the location of the first input and the location of the second input accordingly are moved closer together without coinciding. In some embodiments, if the first input manipulator and the second input manipulator do not move past each other, then the location of the first input and the location of the second input accordingly do not move past each other. When performing, in an environment that includes a user interface, an operation that is controlled at least in part by relative movement between two input manipulators, correlating the location of the two input manipulators in physical space to respective first and second input locations in the environment such that movement of the input manipulators in physical space toward each other without overlapping or crossing moves the corresponding first and second input locations in the environment also without overlapping or crossing reduces the chance of producing a user interface response that is inconsistent with physical reality (e.g., an image that, while being reduced in size as the input manipulators approach each other, flips before the input manipulators have crossed), which reduces mistakes and makes interaction with the computer system more efficient.

In some embodiments, in accordance with a determination that the one or more inputs include a respective input performed using a single input manipulator (e.g., based on a user performing an input using one hand and not both hands) (852), movement of the single input manipulator by a first amount of input movement causes a user interface output (e.g., moving, scrolling, panning, resizing, rotating, zooming, or performing another user interface operation) with a first user interface output magnitude (e.g., a location of the single input manipulator is mapped to a location of the respective input such that movement of the single input manipulator moves the location of the respective input, scaled linearly (e.g., using a multiplier) or non-linearly (e.g., using a non-linear function that is based on an amount or speed of input manipulator movement), so as to cause the corresponding user interface output). In some embodiments, the first amount of relative input movement between the first input manipulator and the second input manipulator causes a user interface output (e.g., moving, scrolling, panning, resizing, rotating, zooming, or performing another user interface operation) with a second user interface output magnitude that is less than the first user interface output magnitude. For example, when the single input manipulator is moved by the first amount of input movement, the first magnitude of the resulting user interface output is greater than the magnitude of a user interface output resulting from the first input manipulator being moved by the first amount of input movement relative to a stationary second input manipulator (e.g., consistent with the respective input being moved by an amount that is greater than the amount by which the first input is moved relative to the stationary second input). More generally, in some embodiments, movement of a single input manipulator by a respective amount causes a corresponding user interface output with a magnitude that is amplified or increased relative to the magnitude of user interface output caused by the same respective amount of movement by first and second input manipulators relative to each other. For example, as described herein with reference to FIGS. 7D-7E, the input movement magnitude d_{acc} is optionally accelerated relative to the corresponding amount of movement of hand 7020, whereas in contrast, as described herein with reference to FIGS. 7J-7K, the change in input location from location 7026 to location 7030 is optionally not accelerated relative to the corresponding amount of movement of hand 7020. Producing a user interface output responsive to an input by a single input manipulator and with a magnitude that is augmented more relative to a particular amount of movement of the single input manipulator, versus producing a user interface output responsive to inputs by two input manipulators and with a magnitude that is augmented less relative to the same particular amount of movement of the two input manipulators relative to each other, increases the responsiveness of the user interface to the single input manipulator, thereby improving ergonomics by requiring less movement for a given magnitude of user interface output, while coordinating the user interface response for more complex inputs that use two input manipulators to increase precision, thus reducing mistakes and making interaction with the computer system more efficient.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve input processing during XR experiences of users. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve input processing during an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of input processing during XR experiences, the present technology can be configured to allow users to select to “opt in” or “opt out” of participation in the collection of personal information data during registration for services or anytime thereafter. In another example, certain data about a user, such as detailed information about the features of the user that are providing user input and/or the locations of such features (e.g., eye(s), hand(s), finger(s), wrist(s), head, and/or other features), are initially not provided to software that is receiving the user input, unless the software has a need for and explicitly requests the data. In addition, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, input processing during an XR experience can be performed by inferring preferences based on non-personal information data or a bare minimum amount of personal information, such as the content being requested by the device associated with a user, other non-personal information available to the service, or publicly available information.

What is claimed is:

1. A method, comprising:
at a computer system that is in communication with a display generation component and one or more input devices:
while a view of an environment is visible via the display generation component, displaying a user interface including one or more user interface objects;
detecting, via the one or more input devices, one or more inputs; and,
in accordance with a determination that the one or more inputs include a first input performed using a first input manipulator and a second input performed using a second input manipulator distinct from the first input manipulator, where the first input and the second input meet concurrency criteria:
providing a first input event for the first input to a first application, wherein the first input event includes information identifying a target location; and
providing a second input event for the second input to the first application, wherein the second input event includes information identifying the target location.

2. The method of claim 1, including:
in accordance with a determination that the one or more inputs include a respective input performed using a single input manipulator without receiving another input that meets the concurrency criteria, performing a respective operation corresponding to the respective input performed using the single input manipulator.

3. The method of claim 1, including:
in accordance with a determination that the one or more inputs include the first input performed using the first input manipulator and the second input performed using the second input manipulator and that the first input and the second input do not meet the concurrency criteria:
performing a first operation corresponding to the first input performed using the first input manipulator; and
performing a second operation corresponding to the second input performed using the second input manipulator, wherein the second operation is distinct from the first operation.

4. The method of claim 1, including:
in accordance with the determination that the one or more inputs include the first input and the second input where the first input and the second input meet the concurrency criteria, performing an operation in accordance with relative movement between the first input manipulator and the second input manipulator.

5. The method of claim 4, wherein performing the operation includes:
in accordance with a determination that a first magnitude of relative movement occurs between the first input manipulator and the second input manipulator, performing the operation with a first operation magnitude; and
in accordance with a determination that a second magnitude of relative movement occurs between the first input manipulator and the second input manipulator, wherein the second magnitude of relative movement is different from the first magnitude of relative movement, performing the operation with a second operation magnitude that is different from the first operation magnitude.

6. The method of claim 4, wherein the target location corresponds to a respective user interface object of the one or more user interface objects.

7. The method of claim 6, wherein performing the operation includes rotating the respective user interface object.

8. The method of claim 6, wherein performing the operation includes changing a zoom scale of the respective user interface object.

9. The method of claim 6, wherein performing the operation includes panning the respective user interface object.

10. The method of claim 1, wherein detecting the one or more inputs includes detecting one or more air gestures.

11. The method of claim 1, wherein determining that the first input and the second input meet the concurrency criteria includes determining that the second input is detected within a first threshold amount of time since detecting the first input.

12. The method of claim 11, wherein determining that the first input and the second input meet the concurrency criteria also includes determining that a threshold amount of relative movement between the first input manipulator and the second input manipulator is detected within a second threshold amount of time.

13. The method of claim 1, wherein the first input corresponds to a first location in the user interface different from the target location, and the second input corresponds to a second location in the user interface different from the target location.

14. The method of claim 1, wherein the target location corresponds to a location in the environment to which a user's attention is directed.

15. The method of claim 1, wherein detecting the one or more inputs includes detecting the first input performed using the first input manipulator prior to detecting the second input performed using the second input manipulator, and the method includes:
in response to detecting the first input performed using the first input manipulator, prior to detecting the second input performed using the second input manipulator:
providing, to the first application, a third input event corresponding to the first input manipulator.

16. The method of claim 15, wherein detecting the one or more inputs includes detecting the second input performed using the second input manipulator, and the method includes:
in response to detecting the second input performed using the second input manipulator:
providing, to the first application, a fourth input event that includes an instruction to the first application to cancel or ignore the third input event.

17. The method of claim 15, including:
in response to detecting the second input performed using the second input manipulator, delaying providing an input event for the second input to the first application.

18. The method of claim 17, including:
after delaying providing an input event for the second input to the first application, detecting an end of the second input performed using the second input manipulator; and
in response to detecting the end of the second input, in accordance with a determination that the concurrency criteria are not met, providing, to the first application, an input event for the second input.

19. The method of claim 17, including:
after delaying providing an input event for the second input to the first application, in accordance with a determination that the concurrency criteria are not met, providing, to the first application, an input event for the second input.

20. The method of claim 17, wherein the first application is configured to, in response to receiving the input event for the second input, perform a selection operation with respect to a respective user interface object.

21. The method of claim 1, wherein:
in accordance with the determination that the one or more inputs include the first input performed using the first input manipulator and the second input performed using the second input manipulator, where the first input and the second input meet the concurrency criteria:
a location of the first input manipulator is mapped to a location of the first input, and a location of the second input manipulator is mapped to a location of the second input, such that relative movement between the first input manipulator and the second input manipulator without the first input manipulator and the second input manipulator crossing moves the first input and the second input relative to each other without the location of the first input and the location of the second input crossing.

22. The method of claim 21, wherein:
in accordance with a determination that the one or more inputs include a respective input performed using a single input manipulator, movement of the single input manipulator by a first amount of input movement causes a user interface output with a first user interface output magnitude, wherein:
the first amount of relative input movement between the first input manipulator and the second input manipulator causes a user interface output with a second user interface output magnitude that is less than the first user interface output magnitude.

23. A computer system that is in communication with a display generation component and one or more input devices, the computer system comprising:
one or more processors; and
memory storing one or more programs configured to be executed by the one or more processors, the one or more programs including instructions for:
while a view of an environment is visible via the display generation component, displaying a user interface including one or more user interface objects;
detecting, via the one or more input devices, one or more inputs; and,
in accordance with a determination that the one or more inputs include a first input performed using a first input manipulator and a second input performed using a second input manipulator distinct from the first input manipulator, where the first input and the second input meet concurrency criteria:
providing a first input event for the first input to a first application, wherein the first input event includes information identifying a target location; and
providing a second input event for the second input to the first application, wherein the second input event includes information identifying the target location.

24. A computer-readable storage medium storing one or more programs configured to be executed by one or more processors of a computer system that is in communication with a display generation component and one or more input devices, the one or more programs including instructions for:
while a view of an environment is visible via the display generation component, displaying a user interface including one or more user interface objects;
detecting, via the one or more input devices, one or more inputs; and,
in accordance with a determination that the one or more inputs include a first input performed using a first input manipulator and a second input performed using a second input manipulator distinct from the first input manipulator, where the first input and the second input meet concurrency criteria:
providing a first input event for the first input to a first application, wherein the first input event includes information identifying a target location; and
providing a second input event for the second input to the first application, wherein the second input event includes information identifying the target location.
